(19) United States
(12) Patent Application Publication
(10) Pub. No.: US 2016/0223750 A1
(43) Pub. Date: Aug. 4, 2016

(54) SYSTEM FOR OPTICALLY COUPLING OPTICAL FIBERS AND OPTICAL WAVEGUIDES

(71) Applicant: Cisco Technology, Inc., San Jose, CA (US)

(72) Inventors: Kalpendu Shastri, Orefield, PA (US); Ravi Sekhar Tummidi, Breinigsville, PA (US); Vipulkumar Patel, Breinigsville, PA (US)

(21) Appl. No.: 14/613,025

(22) Filed: Feb. 3, 2015

(51) Int. Cl. G02B 6/30

(52) U.S. Cl. CPC G02B 6/30

(57) ABSTRACT

An optical coupler may include a fiber optic structure that has a portion of an outer surface that extends in a longitudinal direction of the fiber optic structure. The longitudinal outer surface portion may be optically coupled with a waveguide core of an optical integrated circuit. The fiber optic structure may also include a second outer surface that extends transverse to the longitudinal direction of the fiber optic structure. The fiber optic structure may also include a third outer surface portion that is butt coupled to an end of an optical fiber to optically couple the third outer surface portion with the optical fiber.

### TECHNICAL FIELD

The present disclosure relates generally to optical couplers, and more particularly to a fiber optic structure with a longitudinal surface configured to optically couple an optical waveguide with an optical fiber.

### BACKGROUND

Optical or light signals carrying information may be transmitted over optical communication links, such as optical fibers or fiber optic cables. Optical integrated circuits may receive the optical signals and perform functions on the optical signals. Communicating the optical signals between the optical fibers and the optical integrated circuits with a maximum amount of coupling efficiency is desirable. Alignment techniques, including active and passive alignment techniques, may be used to achieve maximum coupling efficiency. Active alignment may be costly because it involves active electronics and feedback loops.

### BRIEF DESCRIPTION OF THE DRAWINGS

FIG. 1 illustrates a top view of a front end of an optical integrated circuit and an end of an optical fiber.

FIG. 2 illustrates an axial cross-sectional view of an optical fiber.

FIG. 3 illustrates a cross-sectional side view of an example optical coupler.

FIG. 4 illustrates perspective view of the example optical coupler in FIG. 3.

FIG. 5 illustrates a cross-sectional axial view of the example optical coupler in FIG. 3.

FIG. 6. illustrates a second cross-sectional axial view of the example optical coupler in FIG. 3.

FIG. 7 illustrates a third cross-sectional axial view of the example optical coupler in FIG. 3.

FIG. 8A illustrates a cross-sectional axial view of an alternative example optical coupler.

FIG. 8B illustrates a cross-sectional axial view of a second alternative example optical coupler.

FIG. 8C illustrates a cross-sectional axial view of a third alternative example optical coupler.

FIG. 9 illustrates a side view of an optical coupler formed from an optical fiber.

FIG. 10 illustrates a cross-sectional side view of a fourth alternative example optical coupler.

FIG. 11 illustrates a cross-sectional axial view of the optical coupler in FIG. 10.

FIG. 12 illustrates a cross-sectional side view of a fifth alternative example optical coupler.

FIG. 13 illustrates a cross-sectional axial view of the optical coupler in FIG. 12.

FIG. 14 illustrates a cross-sectional side view of a sixth alternative example optical coupler.

FIG. 15 illustrates a cross-sectional axial view of the optical coupler in FIG. 14.

FIG. 16 illustrates a cross-sectional side view of an example optical system.

FIG. 17A illustrates a cross-sectional axial view of the example optical system in FIG. 16, showing an example embodiment of a top layer of optical system.

FIG. 17B illustrates another cross-sectional axial view of the example optical system in FIG. 16, showing an alternative example embodiment of the top layer.

FIG. 17C illustrates another cross-sectional axial view of the example optical system in FIG. 16, showing a second alternative example embodiment of the top layer.

FIG. 17D illustrates another cross-sectional axial view of the example optical system in FIG. 16, showing a third alternative example embodiment of the top layer.

FIG. 17E illustrates another cross-sectional axial view of the example optical system in FIG. 16, showing a fourth alternative example embodiment of the top layer.

FIG. 17F illustrates another cross-sectional axial view of the example optical system in FIG. 16, showing a fifth alternative example embodiment of the top layer.

FIG. 17G illustrates another cross-sectional axial view of the example optical system in FIG. 16, showing a sixth alternative example embodiment of the top layer.

FIG. 18 illustrates an exploded view of the example optical system in FIG. 16.

FIG. 18A illustrates the coupling efficiency of variations of the example optical system in FIG. 16.

FIG. 19 illustrates a cross-sectional axial view of the example optical system, showing an optical fiber disposed in a support structure.

FIG. 20 illustrates another cross-sectional axial view of the example optical system, showing an optical coupler disposed in a support structure.

FIG. 21 illustrates a cross-sectional side view of an example optical coupler disposed in an example housing.

FIG. 22 illustrates a cross-sectional axial view of the optical coupler and housing in FIG. 21.

FIG. 23 illustrates a cross-sectional side view of an example coupler disposed in an alternative example housing.

FIG. 24 illustrates a cross-sectional axial view of the optical coupler and alternative housing in FIG. 23.

FIG. 25 illustrates an axial view of an alternative optical system that includes a plurality of optical couplers.

FIG. 26 illustrates an axial view of another alternative optical system that includes a plurality of optical couplers disposed in a housing.

FIG. 26A illustrates a top view of the optical system in FIG. 26, showing the optical system optically coupled to a multi-core optical fiber.

FIG. 27 illustrates a flow diagram of an example method of manufacturing an optical coupler and optically coupling the optical coupler with an optical integrated circuit and an optical fiber.

FIG. 28 illustrates a flow diagram of another example method of manufacturing an optical coupler.

### DETAILED DESCRIPTION

Overview

An apparatus includes an optical coupler that has a fiber optic structure that comprises a core portion and a cladding portion. The fiber optic structure also has an outer surface that includes a first outer surface portion configured to optically couple the optical coupler with an optical waveguide. The first outer surface portion extends in a longitudinal direction of the fiber optic structure. The outer surface also includes a second outer surface portion that is adjacent to the first outer surface portion. The second outer surface portion extends transverse to the longitudinal direction of the fiber optic structure. The outer surface also includes a third outer surface portion configured to optically couple the optical coupler with an optical fiber.

Another apparatus includes an optical coupler configured to optically couple a waveguide core of an optical integrated circuit with an optical fiber. The optical coupler includes a fiber optic structure that comprises a core portion and a cladding portion. The fiber optic structure has a flat outer surface portion that extends in a longitudinal direction of the fiber optic structure, where the flat outer surface portion comprises both the core portion and the cladding portion.

A system includes an optical waveguide structure of an optical integrated circuit. The optical waveguide structure includes a substrate and a waveguide core forming an optical waveguide path disposed on the substrate. The system also includes an optical coupler disposed over the waveguide core. The optical coupler includes a fiber optic structure that comprises a core portion and a cladding portion. An outer surface of the fiber optic structure includes a first outer surface portion that extends in a longitudinal direction of the fiber optic structure, where the first outer surface portion is a substantially flat surface that includes the core portion and the cladding portion. Also, the first outer surface portion faces the waveguide core to optically couple the optical coupler with the waveguide core. The outer surface also includes a second outer surface portion adjacent to the first outer surface portion. The second outer surface portion extends transverse to the longitudinal direction of the fiber optic structure. The outer surface also includes a third outer surface portion that includes the core portion and the cladding portion.

### Description of Example Embodiments

The present disclosure describes an optical coupler or coupling mechanism that is configured to optically couple one or more optical waveguides or waveguide paths with one or more optical fibers. The optical waveguides may be included with or as part of an optical waveguide structure, which may be located “on chip” or included as part of an optical integrated circuit (IC). The optical IC may be configured to process or perform functions on optical signals, such as modulation, bending light, coupling, and/or switching, as examples. The optical fibers may be optical components that are external to the optical IC. The optical fibers may be configured to communicate or carry the optical signals to and/or away from the optical IC. The optical coupler may be configured to optically couple the optical waveguide paths with the optical fibers so that the optical signals may be communicated between the optical IC and the optical fibers with optimum coupling efficiency (or minimum coupling loss).

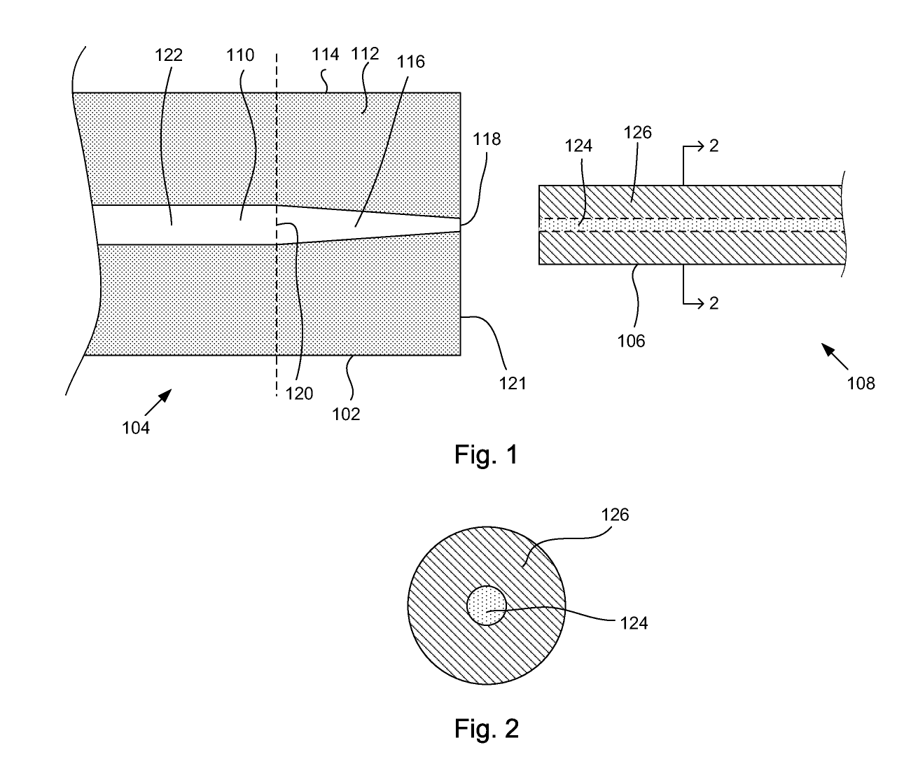

FIG. 1 shows a top view of an example IC front end 102 of an optical IC 104 and an example fiber end 106 of an optical fiber 108. The optical IC 104 and the optical fiber 108 may be configured to communicate optical signals between each other through the IC front end 102 and the fiber end 106. The IC front end 102 may include an optical waveguide or waveguide structure that may include an optical waveguide core 110 disposed on a top planar surface 112 of a substrate 114. The waveguide structure may also include an optical waveguide cladding (not shown in FIG. 1) that encases or surrounds the optical waveguide core 110. The optical waveguide core 110 may make up or form an optical waveguide path through which optical signals may propagate. FIG. 1 shows an example configuration of the IC front end 102 that includes a single waveguide core 110 making up a single optical waveguide path. In alternative example configurations, multiple optical waveguide cores making up multiple optical waveguide paths may be included in the IC front end 102. The optical waveguide path may communicate optical signals to and from processing circuitry (not shown) of the optical IC that performs the functions on the optical signals.

The optical waveguide core 110 may include a nanotaper 116 (also referred to as taper or an inverse taper) to couple optical signals received from the optical fiber 108 to the IC front end 102 and/or to couple optical signals to be transmitted to the optical fiber 108 away from the IC front end 102. The nanotaper 116 may have an associated length extending in the direction of propagation from a first end 118 to a second end 120. In addition, the nanotaper 116 may inversely taper or increase in width from a first end 118 to a second end 120. The first end 118 may be located at or near (e.g., a couple of microns away from) an edge 121 of the substrate 114 of the optical IC 104. At the first end 118, the nanotaper 116 may have a width such that the optical mode at the first end 118 matches or substantially matches the mode of the optical fiber 108 and hence supports an optical fiber mode of the optical signals received from optical fiber 108. The second end 120 may have a width that supports a waveguide mode of the optical signals in the optical waveguide structure. At the second end 120, optical signals may be confined or concentrated to the optical waveguide structure.

The nanotaper 116 may increase in width from the first end 118 to the second end 120 in various ways. In one example configuration of the nanotaper 116, as shown in FIG. 1, the width of the nanotaper 116 may have a linear profile in which the nanotaper 116 linearly increases in width from the first end 118 to the second end 120. In alternative configurations, the width of the nanotaper 116 may increase in accordance with other profiles, such as a non-linear profile (e.g., an exponential or higher-order polynomial profiles) as an example. In addition or alternatively, the nanotaper 116 may have different profiles for its two opposing longitudinally extending sides. For example, one side may linearly extend from the first end 118 to the second end 120, and the opposing side may non-linearly extend from the first end 118 to the second end 120. Additionally, for some example configurations, the nanotaper 116 may be a single-segmented structure in which the width of the nanotaper 116 may continuously increase in accordance with a single profile from the first end 118 to the second end 120, as shown in FIG. 1. In alternative configurations, the nanotaper 116 may be a multi-segmented structure in which the width of the nanotaper 116 may increase differently in accordance with different profiles over different segments of the multi-segmented nanotaper 116. Various configurations or combinations of configurations for the nanotaper 116 are possible.

Additionally, the nanotaper 116 may be an adiabatic optical waveguide structure, in which minimal energy loss occurs as the optical signals propagate over the adiabatic structure. To achieve or ensure minimal energy loss, the length of the nanotaper 116 may be sufficient to cause or enable single modal propagation of the optical signals through the nanotaper 116 with minimal or no coupling of optical energy to other optical modes or radiation modes. The length of the nanotaper 116 may be significantly greater than the wavelengths of the optical signals, and the closer in effective index the modes are, the longer the length may be. In some cases the length may be at least ten times greater than the wavelengths.

As shown in FIG. 1, the optical waveguide core 110 making up the optical waveguide path may also include a uniform waveguide portion 122 connected to the second end 120 of the nanotaper 116. The uniform waveguide portion 122 may have a substantially uniform width through which optical signals may be confined to the optical waveguide path and may be communicated between the nanotaper 116 and other portions of the optical IC 104, such as processing circuitry (not shown).

The optical fiber 108 may include a fiber optic core 124 (denoted by dots), and a fiber optic cladding 126, which may surround the fiber optic core 124. The fiber optic core 124 and cladding 126 may each be made of an optical fiber material. Example fiber optic materials may include glass or plastic, and the material used for the cladding 126 may have a lower index of refraction than the core 124, although other types of fiber optic materials and/or index of refraction configurations for either single or multimode operation, either currently existing or later developed, may be used.

As shown in FIG. 2, the optical fiber 108 may have a generally circular cross-sectional axial profile, which may be defined or determined by the cross-sectional axial shape of the fiber optic cladding 126. The fiber optic core 124 may similarly have a circular cross-sectional axial shape. Each of the fiber optic core 124 and the fiber optic cladding 126 may have an associated cross-sectional axial size, which may be defined or determined by their respective diameters.

The optical fiber 108 shown in FIGS. 1 and 2 may be single-core optical fiber of various types. For example, the optical fiber 108 may be a single-mode optical fiber that is configured to transmit optical signals in a single fiber optic mode. Example diameters for a single-mode optical fiber 108 may include a core diameter between 8 and 10.5 micrometers (μm or microns), such as 9 μm, and a cladding diameter of 125 μm, although optical fibers having other diameters may be used. Alternatively, the optical fiber 108 may include a multi-mode optical fiber configured to transmit optical signals in multiple fiber optic modes. In addition or alternatively, the optical fiber 108, either as a single-mode or a multi-mode optical fiber, may be a polarization-maintaining optical fiber (PMF). Examples of currently existing and commercially available optical fibers may include Corning® SMF28®, Corning® SMF28e®, Corning® SMF28e+®, Corning® ClearCurve®, Corning® ClearCurve® ZBL, or Fujikura PANDA polarization maintaining optical fiber, as examples. Other types of single-core optical fibers may be used. In alternative configurations, instead of being a single-core optical fiber, the optical fiber 108 may be a multi-core optical fiber configured to be optically coupled with multiple waveguide paths of the optical IC 104, as described in further detail below.

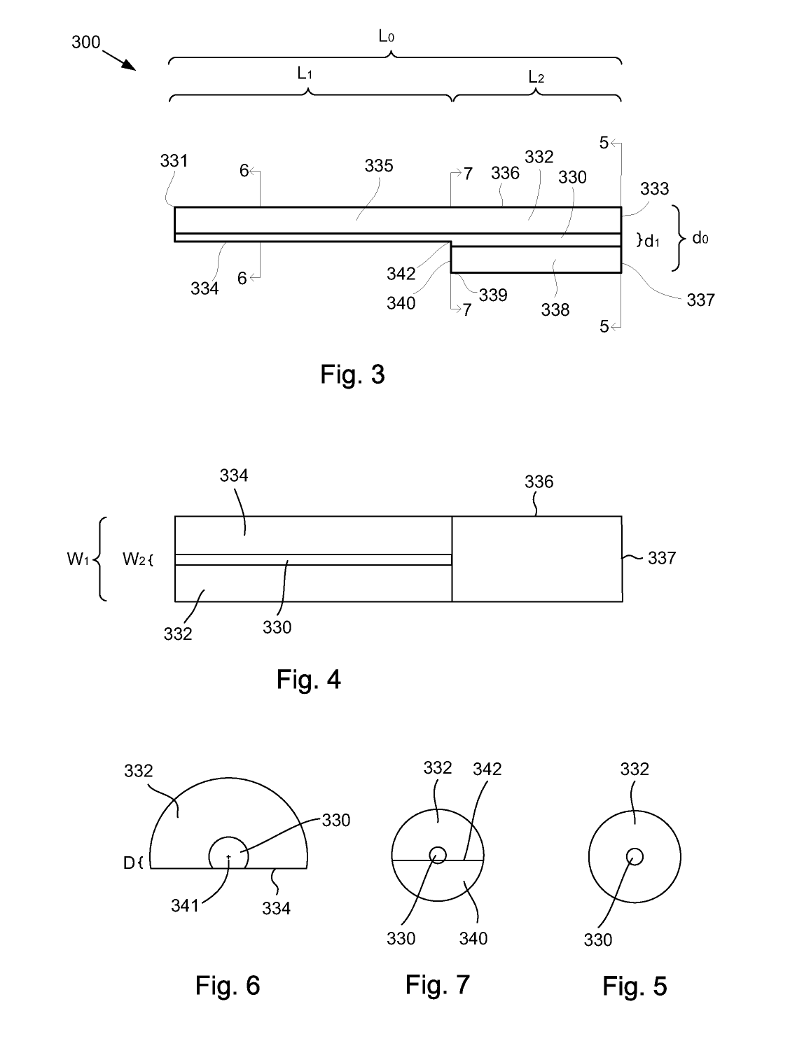

FIGS. 3-7 show various views of an example optical coupler 300 that may be configured to optically couple an optical waveguide or waveguide path of a front end of an optical IC and a fiber end of a single-core optical fiber, such as the IC front end 102 of the optical IC 104 and the fiber end 106 of the optical fiber 108 shown in FIGS. 1 and 2. FIG. 3 shows a cross-sectional side view of the optical coupler 300 taken along a central axis of the optical coupler. FIG. 4 shows a perspective view of the optical coupler 300 shown in FIG. 3 rotated 90 degrees. FIGS. 5-7 are cross-sectional axial views of the optical coupler 300 taken along lines 5-5, 6-6, and 7-7, respectively. FIG. 6 has been enlarged for clarity.

The optical coupler 300 may include a fiber optic structure extending an overall longitudinal length L₀ from a first end 331 to a second end 333. By being a fiber optic structure, the optical fiber 300 may include a core portion 330 and a cladding portion 332. The core and cladding portions 330, 332 may be made of optical fiber materials, such as glass or plastic, which may be the same or similar to the optical fiber materials making up the core 124 and cladding 126 of the optical fiber 108 shown in FIG. 1. The optical coupler 300, being a fiber optic structure, may be formed from an optical fiber having a cladding diameter d₀ and a core diameter d₁. The cladding diameter d₀ may be a maximum outer diameter of the cladding portion 332 over its axial cross-section, and the core diameter d₁ may be a maximum outer diameter of the core portion 330 for the optical coupler 300 over its axial cross-section.

The optical coupler 300 may include a contact portion 335 having a longitudinal outer surface portion 334 and a transverse outer surface portion 340 of an outer surface of the optical coupler 300. The longitudinal outer surface portion 334 may extend in a longitudinal direction of the optical coupler 300. The longitudinal outer surface portion 334 may extend parallel or substantially parallel to a longitudinal axis of the optical coupler 300 from a first end 331 to a second end 339. The longitudinal axis of the optical coupler 300 may extend through the center of the optical coupler 300. The longitudinal outer surface portion 334 may be rectangular in shape. The transverse outer surface portion 340 may be adjacent to the longitudinal outer surface portion 334. The transverse outer surface portion 340 may be perpendicular or substantially perpendicular to the longitudinal outer surface portion 334. The transverse outer surface portion 340 may be semi-circular in shape, as shown in FIG. 7. The longitudinal outer surface portion 334 and the transverse outer surface portion 340 may both contact edge or corner 342, as shown in FIGS. 3 and 7.

The longitudinal surface portion 334 and the transverse outer surface portion 340 may include both the core portion 330 and the cladding portion 332 of the fiber optic structure, as shown in FIGS. 3, 4, and 7. Over the longitudinal surface portion 334 and the transverse outer surface portion 340, the core and cladding portion 330, 332 may be flush or co-planar with each other so that the surfaces are substantially smooth or flat, planar surfaces. In addition, the longitudinal surface portion 334 may be an exposed outer surface in that the longitudinal surface portion 334 and the transverse outer surface portion 340 may expose the core portion 330 to outer surroundings of the optical coupler 300. As shown in FIG. 4, each of the core and cladding portions 330, 332 over the exposed longitudinal surface portion 334 may have a rectangular shape. As shown in FIG. 7, each of the core and cladding portions 330, 332 over the transverse outer surface portion 340 may have a semi-circular shape.

An overall width W₁, including the cladding portion, of the exposed longitudinal surface portion 334 and a width W₂ of the core portion 330 of the exposed longitudinal surface portion 334 may be determined relative to the core and cladding diameters d₁, d₀ of the fiber optic structure and by the distance D from the center 341 of the core portion 330 to the exposed longitudinal surface portion 334. The distance D may be best shown in FIGS. 6 (enlarged for clarity) and 8A-8C. The widths W₂ and W₁ of the core and cladding portions 330, 332 of the rectangular shaped longitudinal surface portion 334 may decrease as the distance D increases and may be minimized when D is equal to the radius of the core portion 330. The maximum widths W₂ and W₁ of the core and cladding portions 330, 332 of the rectangular shaped exposed longitudinal surface portion 334 may be equal or substantially equal to the core and cladding diameters d₁ and d₀ when the distance D is at or substantially equal to zero.

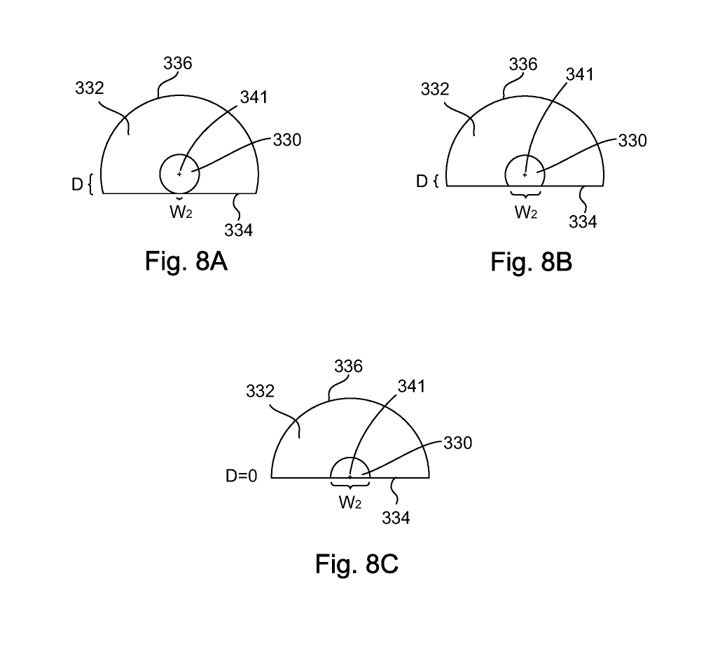

The axial cross-section throughout contact portion 335 may change when the distance D is varied, as shown in FIGS. 8A-8C. The shape of core portion 330 exposed on longitudinal outer surface portion 334 in FIGS. 8A-8C may be rectangular, as shown in FIG. 4. The length of the rectangular exposed core portion 330 may be equal to distance L₁. The width W₂ of the exposed core portion 330 may vary inversely with the distance D. A large distance D may result in a relatively small width W₂ of exposed core portion 330. A small distance D may result in a relatively large width W₂ of exposed core portion 330. FIG. 8A shows the axial cross section of contact portion 335 when the distance D is equal or substantially equal to the radius of core portion 330. The amount of core portion 330 exposed on longitudinal outer surface portion 334 may be minimized when the distance D is equal or substantially equal to the radius of core portion 330. FIG. 8B shows the axial cross section of contact portion 335 when the distance D is less than the radius of core portion 330 but greater than zero. The amount of core portion 330 exposed on longitudinal outer surface portion 334 in FIG. 8B may be similar to the core portion 330 shown in FIG. 4. FIG. 8C shows the axial cross section of contact portion 335 when the distance D is at or substantially equal to zero. The width W₂ of core portion 330 exposed on longitudinal outer surface portion 334 in FIG. 8C may be equal the diameter d₀ of core portion 330. The amount of the core portion 330 exposed on longitudinal outer surface portion 334 may be maximized when the distance D is at or substantially equal to zero, as shown in FIG. 8C. As shown in FIGS. 8A-8C, the core portion 330 may form a semi-circular structure throughout length L₁.

The distance D may vary anywhere from zero to the radius of core portion 330. A negative value of the distance D may indicate that more than half of the core portion 330 has been removed. For example, the distance D may be selected in order to minimize loss as the optical signal transitions through the second end 339 of longitudinal outer surface portion 334. For example, if the radius of core portion 330 is 4.15 μm, the distance D may be 2.15 μm+/−0.2 μm. Additionally or alternatively, the distance D may be determined based on a percentage or ratio of the radius of core portion 330, such as for example, D equals approximately 52% (+/−5%) of the radius of core portion 330. Accordingly, the distance D may be within 47% to 57% of the radius of core portion 330.

The relationship between the amount of core portion 330 exposed on longitudinal outer surface portion 334 may vary based on the axial cross section of core portion 330. A circular axial cross section is shown for core portion 330 in these figures, however any axial cross section shape may be used. For example, if the axial cross section of core portion 330 was rectangular, the amount of core portion 330 exposed on longitudinal outer surface portion 334 may not vary based on the distance D. In addition, the composition of the core and cladding portions 330, 332 making up the axial cross-sections may vary as the distance D varies. For example, some axial cross-sections may include only the cladding portion 332 if longitudinal outer surface portion 334 is located at the top of core portion 330. Other axial cross-sections may include both the core portion 330 and the cladding portion 332, as exemplified in the axial cross-section shown in FIGS. 6 and 8A-8C.

The outer surface of the optical coupler 300 may also include a third exposed surface portion 337 that includes both the core portion 330 and the cladding portion 332. The third exposed surface portion 337 may be separated from the longitudinal exposed surface portion 334 by a uniform portion 338 of the optical coupler 300. Similar to the longitudinal exposed surface portion 334 and the transverse outer surface portion 340, the third exposed surface portion 337 may expose the core portion 330 to outer surroundings of the optical coupler 300. Also, over the third exposed surface portion 337, the core and cladding portions 330, 332 may be flush or co-planar with each other so that the third exposed surface portion 337 is a substantially smooth or flat, planar surface. As shown in FIG. 5, each of the core and cladding portions 330, 332 over the third exposed surface portion 337 may be circularly shaped and have diameters that are equal or substantially equal to the core and cladding diameters d₁ and d₀, respectively.

The outer surface of the optical coupler 300 may further include another surface portion 336, which may be an unexposed surface portion. The unexposed surface portion 336 may only include the cladding portion 332 and/or may not include the core portion 330. That is, over the unexposed surface portion 336, the cladding portion 332 may cover the core portion 330 or prevent the core portion 330 from being exposed to the outer surroundings of the optical coupler 300. Additionally, the unexposed surface portion 336 of the outer surface may have a shape, such as a rounded shape, that conforms to or tracks an outer surface of a cladding of an optical fiber.

As shown in FIG. 3, the contact portion 335 of the optical coupler 300 may longitudinally extend a first length L₁ from the first end 331 to a second end 339. The lengths of the core and cladding portions 330, 332 of the rectangular shaped longitudinal surface portion 334 may be equal to the first length L₁. Throughout the longitudinal first length L₁, an axial cross-section perpendicular to the longitudinal axis may remain constant in height, cross-sectional shape, and compositional makeup of the core and cladding portions 330, 332 because the longitudinal outer surface portion 334 may be parallel to a longitudinal axis of the optical coupler 300.

The optical coupler 300 may further include a uniform portion 338 connected to and/or formed integral to the contact portion 335. The uniform portion 338 may have a uniform axial cross-section over a longitudinal length L₂, from the second end 333 of the optical coupler 300 to the second end 339 of the longitudinal surface portion 334, where the uniform portion 338 is connected to the contact portion 335. FIGS. 5 and 7 show the axial cross section of the optical coupler 300 being uniform over the longitudinal length L₂.

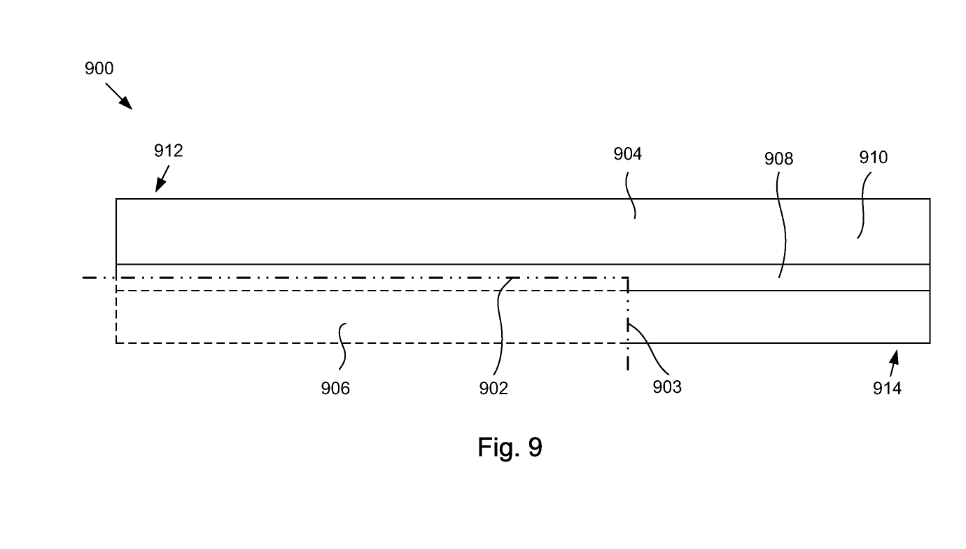

As previously described, the optical coupler 300 may be formed from and/or be a part of an optical fiber. To illustrate, FIG. 9 shows a cross-sectional side view of a fiber end 900 of an optical fiber. Dotted lines 902 and 903 in FIG. 9 divide the end 900 into a first portion 904 and a second portion 906. The first portion 904 is shown using solid lines to denote the portion of the optical fiber used for the optical coupler 300 shown in FIGS. 3-8. The second portion 906 is shown using dotted lines to denote a remaining, unwanted portion that may not be used for the optical coupler 300. Dotted line 902 may represent a cutting line parallel or substantially parallel to a longitudinal axis of the optical coupler 300 along which a first cut in the fiber optic structure may be made. Dotted line 903 may represent a cutting line perpendicular or substantially perpendicular to the longitudinal axis of the optical coupler 300 along which a second cut in the fiber optic structure may be made. As shown in FIG. 9, the dotted line 902 dividing the first and second portions 904, 906 may extend through core and cladding portions 908, 910 of the optical fiber from a first end 912 to a second opposing end 914 at the angle that is parallel or substantially parallel to the longitudinal axis of the optical fiber end 900. Dotted line 903 may extend from dotted line 902 to an exterior surface of the optical fiber and may extend through core and cladding portions 908, 910 of the optical fiber. An example process of making the optical coupler, including removal of the second unwanted portion 906 from the first portion 904 used for the optical coupler is described in further detail below. Longitudinal outer surface portion 334 and transverse outer surface portion 340 may be created by cutting optical coupler 300 along dotted lines 902 and 903. Executing a cut that is parallel or substantially parallel to a longitudinal axis of the optical coupler 300 may reduce the complexity of manufacturing and/or be less costly to manufacture than a cut made at an angle relative to a longitudinal axis of the optical coupler 300.

After the second, unwanted portion 906 is removed from the first portion 904, the optical coupler 300 having the four outer surface portions 334, 336, 337, and 340 shown in FIG. 3 may result. Further portions of the optical coupler 300 may be removed to form various alternative embodiments of the optical coupler 300. In particular, portions beginning from the first end 331 and/or the second end 333 of the optical coupler 300 may be removed, which may reduce an overall size of the optical coupler 300, including a reduction in the overall length L₀ of the optical coupler 300 and/or the first and second lengths L₁ and L₂ associated with the contact portion 335 and the longitudinal surface portion 334; modify shapes, sizes and core and cladding compositional makeup of the longitudinal surface portion 334 and/or third exposed surface portion 337; modify orientations of the longitudinal surface portion 334, the transverse outer surface portion 340, and the third exposed surface portion 337 relative to each other; and/or form additional outer surface portions. Other modifications to the optical coupler 300 may result when the further portions of the optical coupler are removed.

Looking at FIG. 3 in particular, to remove a first further portion of the optical coupler 300 beginning from the first end 331, a first point or position along the longitudinal surface portion 334 from the first end 331 may be determined. The first position may be within a range of possible positions that extends along the longitudinal surface portion 334 between the first end 331 of the optical coupler 300 and the second end 339 of the contact portion 335. After the first position in the range is determined, the first further portion to be removed may be defined by a line segment extending from the first position perpendicular to the longitudinal surface portion 334 to a second point or position on the unexposed surface portion 336. The first further portion of the optical coupler 300 defined by the line segment may then be removed, which may form a fifth outer surface portion adjacent to the longitudinal surface portion 334 and the unexposed surface portion 336. In some example configurations, the line segment may extend at an angle not perpendicular to the longitudinal surface portion 334, so that the fifth outer surface portion, in turn, may be oriented at an angle to the longitudinal surface portion 334.

In addition or alternatively, a second further portion may be removed from the optical coupler 300 beginning from the second end 333. The second further portion of the optical coupler 300 that may be removed may include all or some of the uniform portion 338. In addition or alternatively, a second point or position along the longitudinal surface portion 334 may be determined to remove all or some of the second further portion. The second position may be within a range of possible positions that extends along the longitudinal surface portion 334 between the second end 339 of the longitudinal surface portion 334 and the first end 331 of the contact portion of 335. After the second position in the range is determined, the second further portion to be removed may be defined by a line segment extending from the second position to the unexposed surface portion 336. The second further portion of the optical coupler 300 defined by the line segment may then be removed. When the second further portion is removed, the orientation of the third exposed surface portion 337 may be changed such that the third exposed surface portion 337 is adjacent to the longitudinal surface portion 334 at the second position along the longitudinal surface portion 334. In some example configurations, the line segment may extend perpendicular to the longitudinal surface portion 334, so that the orientation of the third exposed surface portion 337 is perpendicular to the longitudinal surface portion 334.

The axial cross-sectional shape and the compositional makeup of the core and cladding portions 330, 332 at the third exposed surface portion 337 may vary; depending on how much of the second further portion is removed. For example, if only the uniform portion 338 of the optical coupler 300 is removed, the axial cross-section of the optical coupler 300 may be fully rounded, such as completely circular, as shown in FIGS. 5 and 7. Alternatively, if more of the second further portion than the uniform portion 338 is to be removed and the second position along the longitudinal surface portion 334 is determined, then the axial cross-section of the optical coupler 300 over the third exposed surface portion 337 may be partially rounded or semi-circular, as a part of the axial cross-sectional shape will include the flat, planar surface of the longitudinal surface portion 334.

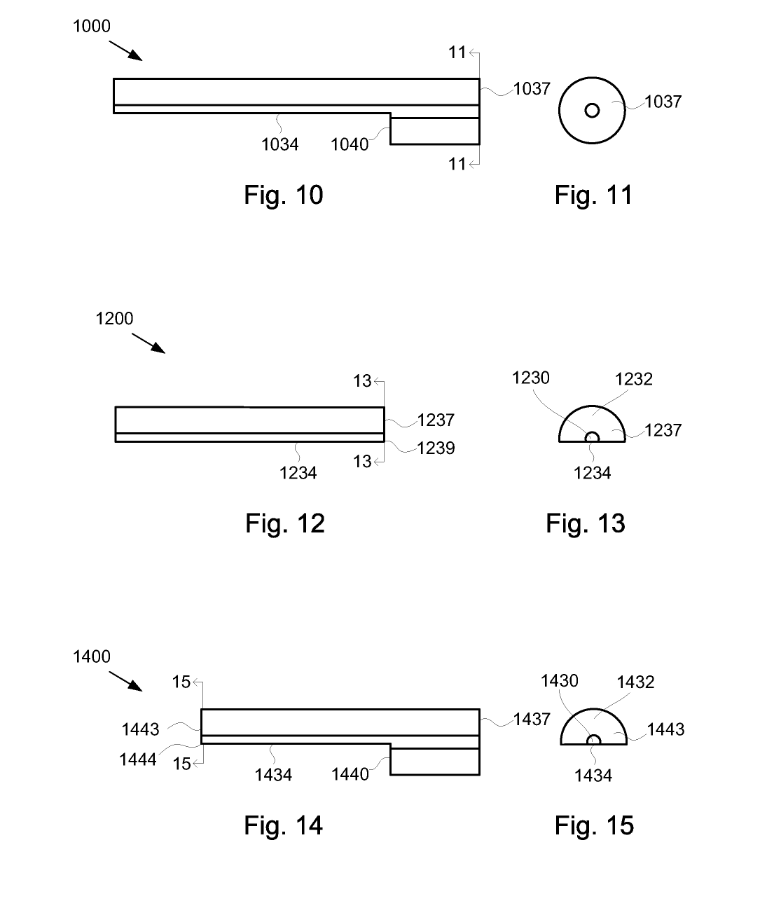

FIGS. 10-15 show cross-sectional side views taken along a central axis and corresponding cross-sectional axial views of various example alternative configurations of the optical coupler 300 when various amounts of a first further portion and/or a second further portion are removed from the optical coupler 300. FIGS. 10-13 show alternative example optical couplers when different amounts of a second further portion, beginning from the second end 333, are removed. FIGS. 14-15 show an alternative example optical coupler when an amount of a first further portion, beginning from the first end 331, is removed. In all of these alternative embodiments, the core and cladding portions are exposed on a longitudinal outer surface portion 334 that may extend in a longitudinal direction of the optical coupler 300.

The alternative example optical coupler 1000 shown in FIGS. 10 and 11 may be formed from the optical coupler 300 when a part of the uniform portion 338 may be removed, which may modify the third exposed surface portion 337 to form an alternative third exposed surface portion 1037. The third exposed surface portion 1037 may be adjacent and oriented perpendicular to a longitudinal surface portion 1034, which may extend in a longitudinal direction of the optical coupler. Also, an axial cross-sectional shape of the optical coupler 1000 at the third exposed portion 1037 may be completely round, such as elliptical or circular, as shown in FIG. 11.

The alternative example optical coupler 1200 shown in FIGS. 12 and 13 may be similar to the alternative optical coupler 1000, except that additional material may be removed from the optical coupler 1000. In particular, in view of FIGS. 10 and 12, a position 1239 along the longitudinal surface portion 1034 may be determined, and a corresponding portion may be removed from the optical coupler 1000 to form a third exposed surface portion 1237 and a longitudinal surface portion 1234 of the optical coupler 1200 shown in FIGS. 12 and 13. Optical coupler 1200 may not include a transverse outer surface portion, as shown in FIG. 12, if the entire uniform portion 338 is removed. Also, the optical coupler 1200 at the second exposed surface portion 1237 may have a semi-circular axial cross-section, as shown in FIG. 13, as the flat, planar surface of the longitudinal surface portion 1234 may be part of the axial cross-section.

FIGS. 14-15 show another alternative example optical coupler 1400 when an amount of a portion of the optical coupler 300, beginning from the first end 331, is removed. The optical coupler 1400 is configured to have third exposed surface portions 1437 configured similarly to the third exposed surface portion 1037 of the optical coupler 1000 shown in FIGS. 10 and 11. However, other configurations for the third exposed surface portions 1437, such as those for the example optical couplers 300 or 1200, may be alternatively used.

With reference to FIGS. 3 and 14, the alternative example optical coupler 1400 may be formed from a determined point or position 1444 along the longitudinal surface portion 334 in between the first end 331 and second end 339 of the longitudinal surface portion 334 to form a longitudinal surface 1434 and a fourth surface portion 1443 of an outer surface of the optical coupler 1400. The fourth surface portion 1443 may be adjacent to the longitudinal surface portion 1434 and oppose the exposed surface portion 1437, in which the optical coupler 1400 may longitudinally extend from the fourth surface portion 1443 to the third exposed surface portion 1437. The fourth surface portion 1443 may be separated from the transverse outer surface portion 1440 by the longitudinal surface 1434. Additionally, as shown in FIG. 14, the fourth surface portion 1443 may be oriented perpendicular to the longitudinal surface portion 1434, although other orientations are possible. As shown in FIG. 14, the fourth surface portion 1443, the transverse outer surface portion 1440, and the third exposed surface portion 1437 may be oriented perpendicular or substantially perpendicular to the longitudinal surface portion 1434, and as such, may be oriented parallel or substantially parallel to each other. As shown in FIG. 15, an axial cross section of the optical coupler 1400 at the fourth surface portion 1443 may be semi-circular. Also, because the position 1444 was in between the ends 331 and 339 of the optical coupler 300, the compositional makeup of the fourth surface portion 1443 may include both a cladding portion 1432 and a core portion 1430, as shown in FIG. 15.

The various optical couplers shown in FIGS. 3-15 are non-limiting examples of optical couplers that may be formed from a fiber optic structure having a longitudinal surface that extends in a longitudinal direction of the optical coupler. Other optical couplers, including optical couplers having different combinations of the features shown in FIGS. 3-15, may be formed in accordance with the above description.

A longitudinal exposed surface portion of an optical coupler, such as those shown in FIGS. 3-15, may be positioned and oriented relative to an optical waveguide to optically couple the optical coupler with the optical waveguide. In particular, the optical coupler may be positioned over the optical waveguide such that the longitudinal exposed surface portion faces and is substantially parallel to the core of the optical waveguide. Additionally, the third exposed surface portion of the optical coupler, such as those shown in FIGS. 3-15, may be used to optically couple the optical coupler with a single-core optical fiber. In particular, the third exposed surface portion may face and be butt coupled with an end of the optical fiber.

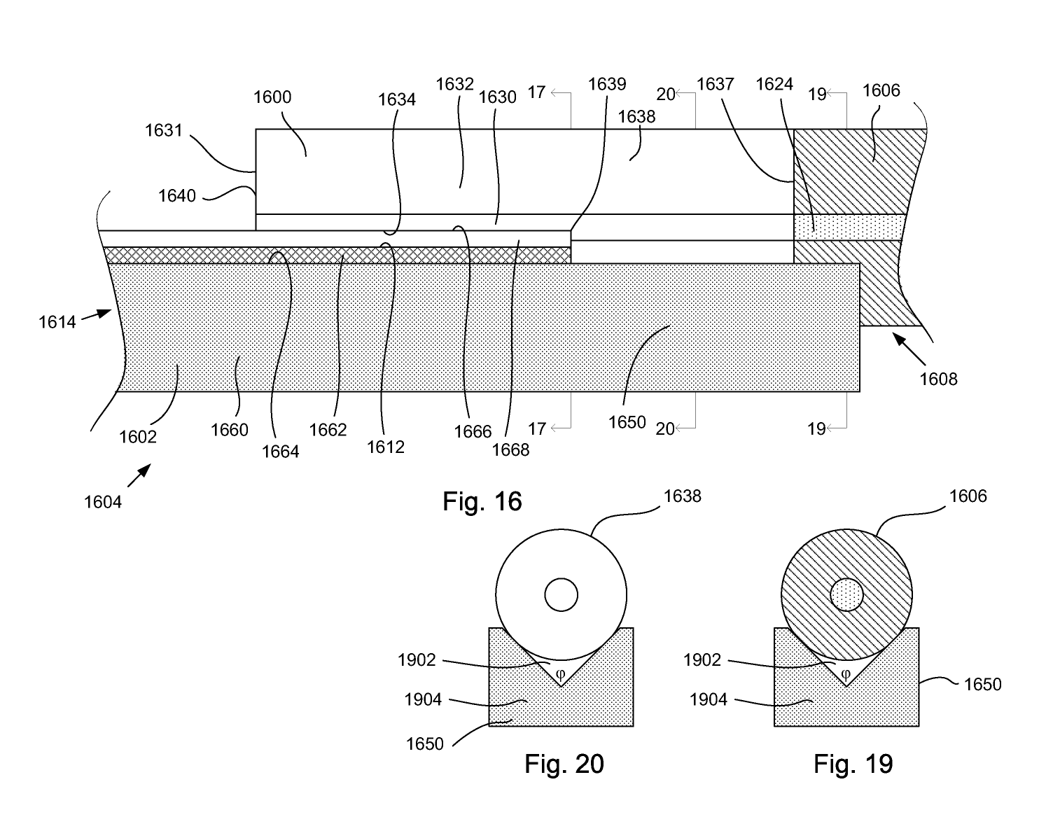

FIG. 16 shows a partial cross-sectional side view of an optical system that includes an optical coupler 1600 optically coupled with an optical waveguide of an IC front end 1602 of an optical IC 1604 and a fiber end 1606 of an optical fiber 1608. The optical coupler 1600 shown in FIG. 16 has the configuration of the example optical coupler 1000 shown in FIG. 10, although other optical couplers configured in accordance with those shown and described above with reference to FIGS. 3-15 may be used.

The IC front end 1602 of the optical IC 1604 may be a generally planar structure that includes one or more planar layers disposed and/or deposited on top of one another. The planar layers may include a top layer 1668 that includes at least a core of the optical waveguide with which the optical coupler 1600 may be optically coupled. The top layer 1668 may be disposed on a top surface 1612 of the other or non-top layers of the planar structure. The other or non-top layers may be generally referred to as the substrate or substrate layers 1614.

The layers of the front end 1602 of the optical IC may be configured in accordance with one of various material technologies or systems used for optical waveguides and optical integrated circuits. In some example configurations, the layers may be configured in accordance with silicon on insulator (SOI), which may be formed using complementary metal-oxide-semiconductor (CMOS) fabrication techniques or SOITEC Smart Cut™ process.

In accordance with SOI, the layers of the IC front end 1602 may include a first, base layer 1660 and a second, buried oxide (BOX) layer 1662 disposed on a top planar surface 1664 of the base layer 1660. The base layer 1660 may be made of silicon (Si), and the BOX layer 1662 may be made of an oxide material, such as silicon dioxide (SiO₂). For purposes of the present description, the base and BOX layers 1660, 1662 may be referred to as the substrate layers 1614 when the IC front end 1602 is configured for SOI. The top layer 1668 may be disposed on a top surface 1612 of the BOX layer 1662. The top layer 1668 may include the core of the optical waveguide, which in accordance with SOI, may be an etched layer of silicon that is disposed on the top surface 1612 of the BOX layer 1662.

To integrate the optical coupler 1600 with the IC front end 1602, the optical coupler 1600 may be positioned over the top layer 1668. In particular, a longitudinal surface portion 1634 of the optical coupler 1600 may face and be disposed on a top surface 1666 of the top layer 1668. When the longitudinal surface portion 1634 is disposed on the top surface 1666 as shown in FIG. 16, the optical coupler 1600 may be optically coupled with the optical waveguide.

The core of the optical waveguide may be included as a sub-layer or portion of the top layer 1668. In addition to the core, the top layer 1668 may include an adhesive sub-layer or portion and/or a cladding sub-layer or portion. The adhesive portion may be used to affix the optical coupler 1600 to the IC front end 1602. The adhesive portion may include an epoxy, such as an optically transparent epoxy, or other type of adhesive material. The cladding portion may be an additional component of the optical waveguide structure that at least partially surrounds or encases the core to confine optical signals to the core as they propagate along the waveguide path.

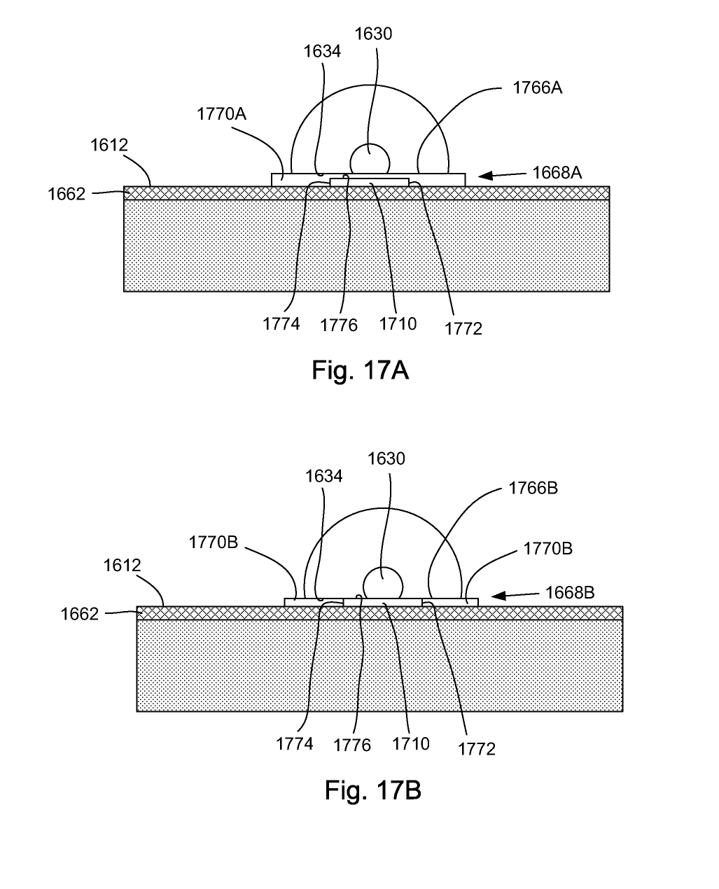

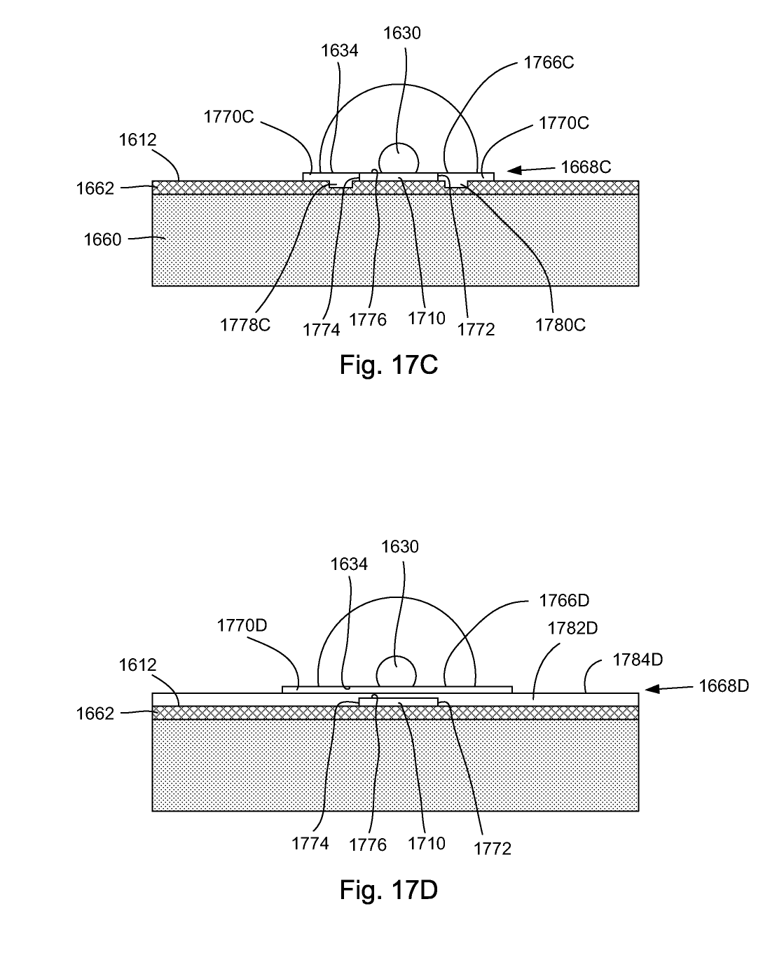

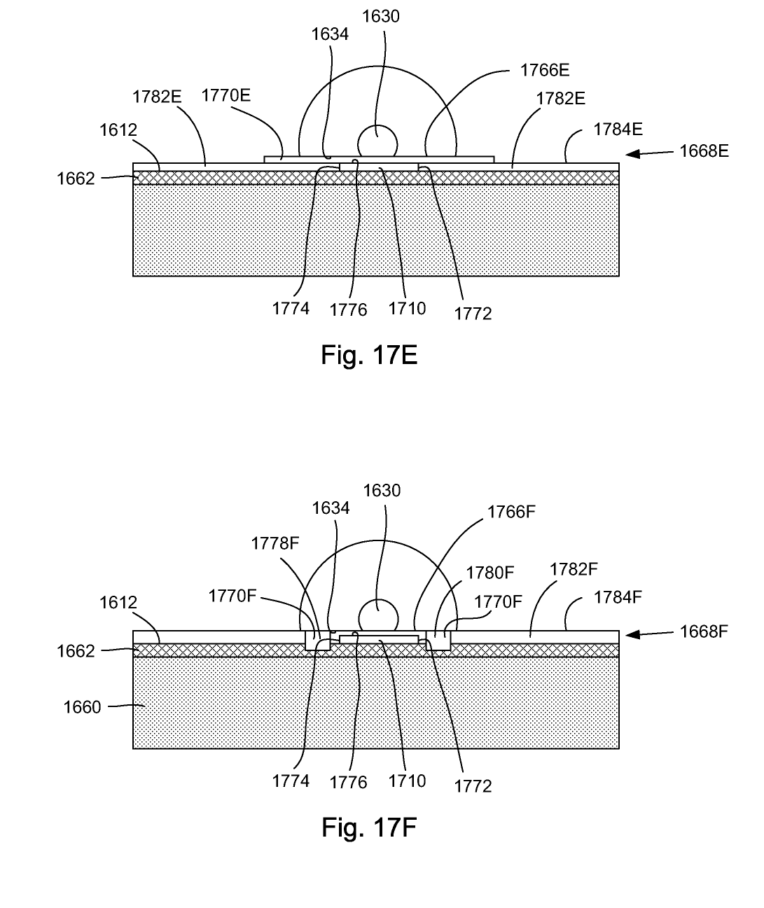

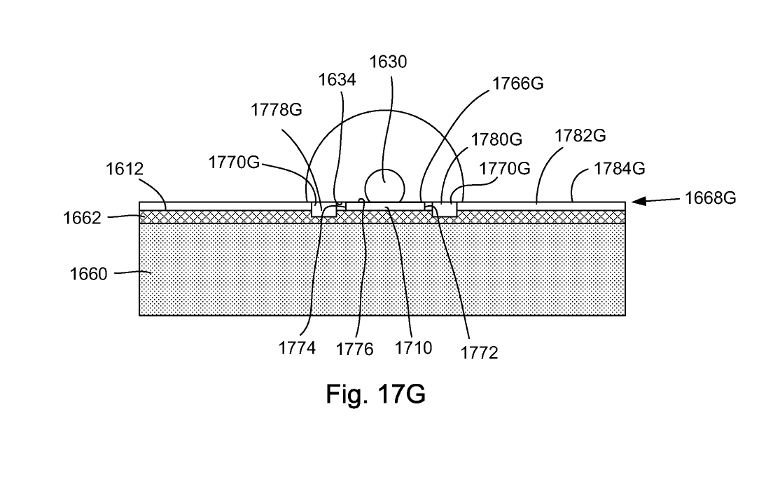

FIGS. 17A-17G show cross-sections of the optical system of FIG. 16 along the line 17-17, illustrating various example configurations of the top layer 1668. All of the configurations include a core 1710 of the top layer 1668 disposed on the top surface 1612 of the BOX layer 1662. FIGS. 17A-17G illustrate various ways in which adhesive and/or cladding portions may be integrated with the core to form an optical waveguide and affix the optical coupler 1600 to the top layer 1668.

In one example configuration of the top layer 1668 shown in FIG. 17A, a top layer 1668A may include an adhesive portion 1770A that is disposed around longitudinally extending sides 1772, 1774 and a top surface 1776 of the core 1710. The longitudinal surface portion 1634 may be disposed on and be in contact with a top surface 1766A, which may include only the adhesive portion 1770A. Additionally, as shown in FIG. 17A, the adhesive portion 1770A may separate a core portion 1630 of the optical coupler 1600 and the top surface 1776 of the core 1710.

In another example configuration of the top layer 1668 shown in FIG. 17B, a top layer 1668B may include an adhesive portion 1770B that is disposed around or adjacent to the sides 1772, 1774 but not the top surface 1776 of the core 1710. In this way, the top surface 1766B may include both the core and adhesive portion. When the optical coupler 1600 is disposed on the top layer 1668B, the core portion 1630 may be in direct contact with the top surface 1776 of the core 1710, and the adhesive portion 1770B on both sides 1772, 1774 of the core 1710 may affix the optical coupler 1600 to the top layer 1668B.

In another example configuration of the top layer 1668 shown in FIG. 17C, an adhesive portion 1770C of a top layer 1668C may be adjacent to the sides 1772, 1774, and may also extend into and/or at least one trench, such as a pair of trenches 1778C, 1780C that may be formed in the BOX layer 1662. The trenches 1778C, 1780C may be formed in the BOX layer 1662 and filled or added with adhesive material to provide an extra thickness or increased bond line for the adhesive portion, which in turn may enhance the adhesive bond between the top layer 1668C and the optical coupler 1600. The trenches 1778C, 1780C may longitudinally extend parallel or substantially parallel with the sides 1772, 1774 of the core 1710 over at least a part of the length of the top layer 1668C over which the optical coupler 1600 may be disposed. Also, FIG. 17C shows the trenches 1778C, 1780C extending partially through the BOX layer 1662. In alternative configurations, the trenches 1778C, 1780C may extend completely through the BOX layer 1662 and/or into the base layer 1660. The trenches 1778C, 1780C may be located a sufficient lateral distance from core 1710 to prevent interference with the optical mode. Additionally, the trenches 1778C, 1780C may be formed using planar lithography and etching techniques. One example etching technique used to form the trenches 1778C, 1780C may be deep reactive ion etching (DRIE), although other etching techniques may be used.

In another example configuration of the top layer 1668 shown in FIG. 17D, a top layer 1668D may include a cladding 1782D surrounding and/or adjacent to the sides 1772, 1774 and the top surface 1776 of the core 1710. An adhesive portion 1770D may be applied to a top surface 1784D of the cladding 1782D. In this way, the adhesive portion 1770D may be included as a top sub-layer of the top layer 1668D. The longitudinal surface portion 1634 may be disposed on the adhesive portion 1770D to be affixed to the IC front end 1602. For the example configuration shown in FIG. 17D, the core 1710 may be separated from the core portion 1630 of the optical coupler 1600 by both the adhesive layer 1770D and the cladding 1782D of the top layer 1668D.

In another example configuration of the top layer 1668 shown in FIG. 17E, a cladding 1782E of a top layer 1668E may be disposed around and/or be adjacent the sides 1772, 1774 of the core, and a top surface 1784E of the cladding 1782E may be co-planar or substantially co-planar with the top surface 1776 of the core 1710. Similar to the configuration shown in FIG. 17D, an adhesive portion 1770E may be included as a top sub-layer of the top layer 1668E and disposed over the top surfaces 1776, 1784E of the core 1710 and cladding 1782E, respectively. The longitudinal exposed surface portion 1634 may be disposed on 1770E to be affixed to the IC front end 1602.

In another example configuration of the top layer 1668 shown in FIG. 17F, a top layer 1668F may include trenches 1778F and 1780F that may be formed in a cladding 1782F and extend into the BOX layer 1662. The trenches 1778F, 1780F may be filled with adhesive 1770F to affix the longitudinal surface portion 1634 of the optical coupler 1600 to a IC front end 1602. As shown in FIG. 17F, the trenches 1778F, 1780F may extend completely through the cladding 1782F, from the top surface 1784F of the cladding and partially through the BOX layer 1662. In alternative example configuration, the trenches 1778F, 1780F may extend only partially through the cladding 1782F. Alternatively, the trenches 1778F, 1780F may extend completely through both the cladding 1782F and the BOX layer 1662 and/or into the base layer 1660. The trenches 1778F, 1780F may be located a sufficient lateral distance from core 1710 to prevent interference with the optical mode. The trenches 1778F, 1780F may be formed using planar lithography and etching techniques, such as DRIE, as previously mentioned. In addition or alternatively, one or more cutting techniques may be used to cut through the cladding 1782F to form at least the portions of the trenches 1778F, 1780F that extend through the cladding 1782F. Additionally, the top layer 1668F is shown to include trenches 1778F, 1780F for a core/cladding configuration where the cladding 1782F surrounds the sides 1772, 1774 and the top surface 1776 of the core 1710. In this way, the top surface 1766F of the top layer 1668F, may include both the top layer 1784F and an adhesive portion 1770F filled in the trenches 1778F, 1780F.

In another example configuration of the top layer 1668 shown in FIG. 17G, trenches 1778G, 1780G filled with adhesive material may be used for a core/cladding configuration where a top surface 1784G of cladding 1782G is co-planar with the top surface 1776 of the core 1710, and the cladding 1782G does not surround the top surface 1776 of the core 1710. For this example configuration, the top surface 1766G of the top layer 1668G may include core, cladding, and adhesive portions that are flush or co-planar with each other. As shown in FIG. 17G, the core portion 1630 of the optical coupler 1600 may be in direct contact with the core 1710.

The example configurations of the top layer 1668F and 1668G are shown using trenches instead of a top adhesive sub-layer to affix the optical coupler 1600 to the IC front end 1602. In alternative configurations, the trenches may be used in combination with a top adhesive sub-layer, such as the top adhesive sub-layers 1770D and 1770E used for the configurations shown in FIGS. 17D and E. The combination of the trenches and the top adhesive sub-layer may be used for the core/cladding configuration where the cladding surrounds the top surface 1776 of the core 1710 and/or for the core/cladding configuration where the top surface of the cladding is co-planar with the top surface 1776 of the core 1710

The cross-sections shown in FIGS. 17A-17G are non-limiting example configurations of a top layer 1768 for the IC front end 1602 that includes a core of an optical waveguide in combination with various configurations of an adhesive portion used to affix the optical coupler 1600 to the IC front end 1602 and an optional cladding portion. Other configurations or combinations of the configurations of the top layer 1768 shown in FIGS. 17A-17G may be possible.

Additionally, FIGS. 17A-17G show the core 1710 as a single-layer structure. However, in alternative configurations, the core 1710 may be a multi-layer structure, such as a double-layer structure. For example, the core may be formed by a partial etching, instead of a complete etching, of a silicon layer disposed on the top surface 1612 of the BOX layer 1662. A thinner layer of silicon formed from the partial etch may remain disposed over the BOX layer 1662, which may be the first layer, and the core forming the waveguide path may be the second layer. In another alternative configuration, the core may include a ribbed structure disposed on a base layer, which may be a nanotaper or uniform waveguide portion determining the waveguide path. The ribbed and base layers may be made of the same or different materials, such as silicon and polycrystalline (polysilicon) or silicon nitride (Si₃N₄), as examples.

In addition, as shown in FIGS. 17A-17G, when the optical coupler 1600 is positioned over the core 1710, the core portion 1630 of the optical coupler 1600 may be axially aligned with the core 1710.

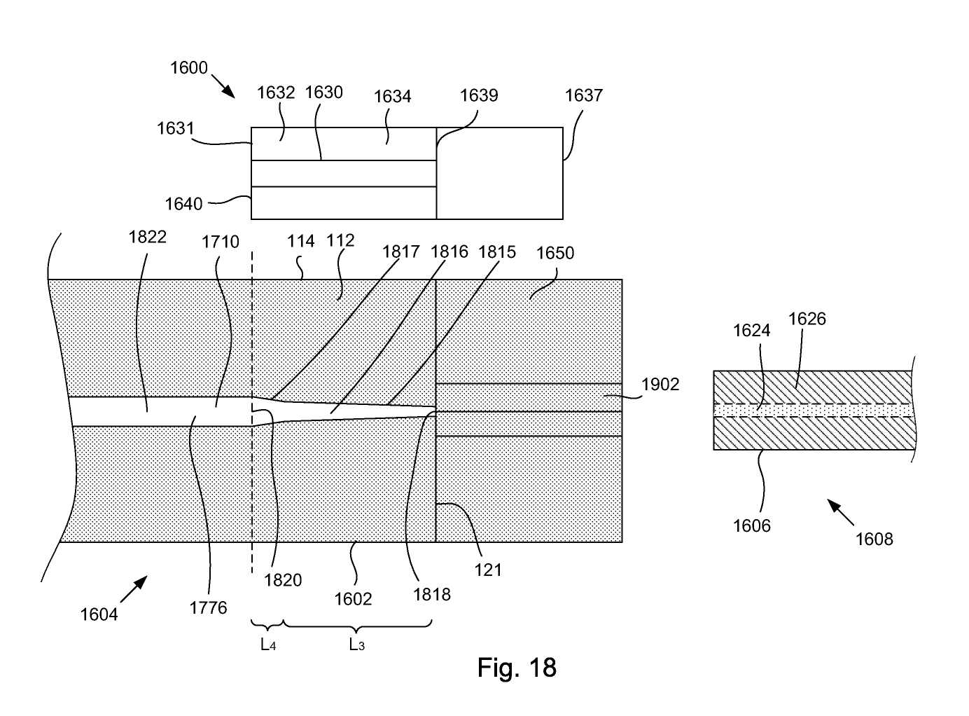

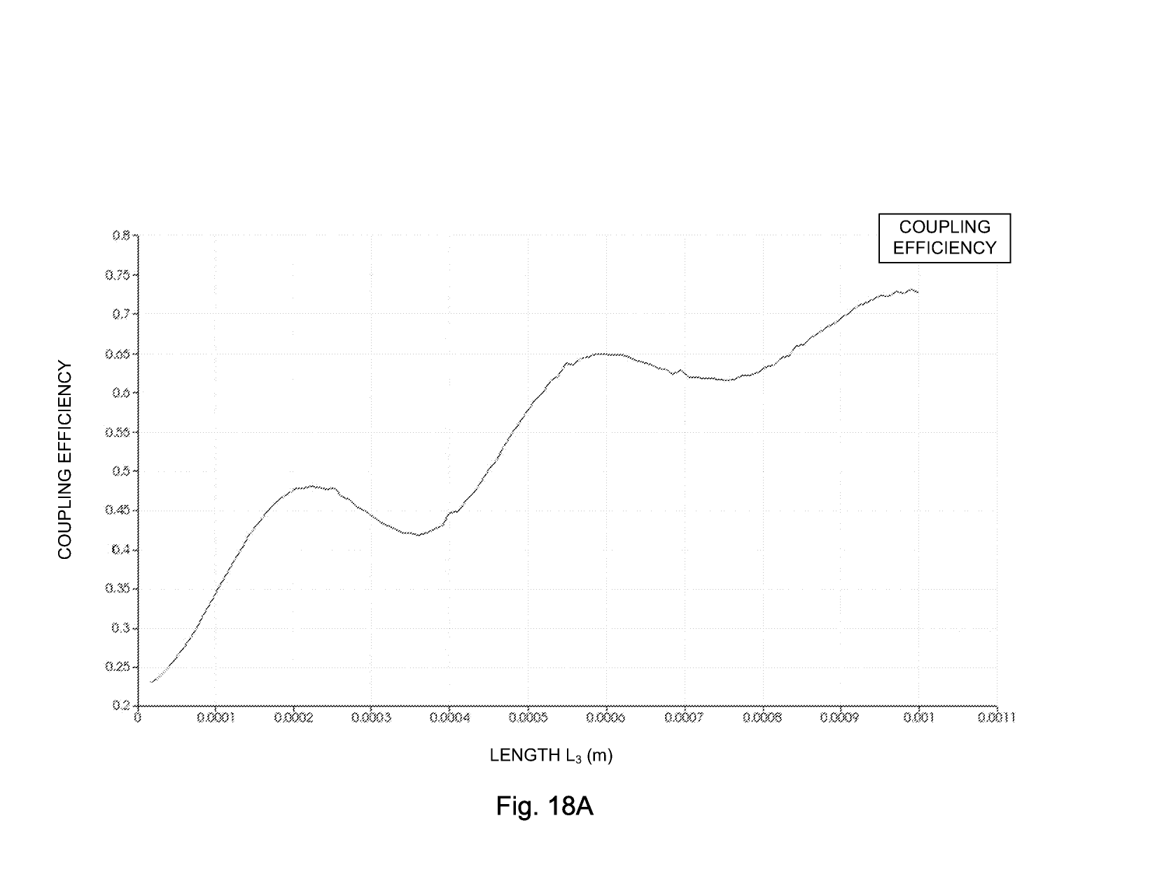

Further, when positioned over the core 1710, the longitudinal surface portion 1634, including the core portion 1630 of the longitudinal surface portion, may be longitudinally aligned with a nanotaper portion of the core 1710. FIG. 18 shows an exploded view of the optical system shown in FIG. 16, with the optical coupler 1600 and the IC front end 1602 rotated ninety degrees, so that the surfaces of the optical coupler 1600 and the IC front end 1602 that face each other (i.e., the longitudinal surface portion 1634 and the top surface 1776 of the core 1710) are shown. The core 1710 may include a nanotaper 1816 connected to uniform waveguide portion 1822, which may be similar to the nanotaper 116 and uniform waveguide portion 122 shown in FIG. 1. The nanotaper 1816 may extend a longitudinal length and increase in width over the longitudinal length from a first end 1818 to a second end 1820.

Nanotaper 1816 may increase in width in multiple segments, such as two linear segments as shown in FIG. 18. The first segment 1815 may increase the width of nanotaper 1816 relatively gradually over length L₃. The second segment 1817 may increase the width of nanotaper 1816 relatively rapidly over length L₄. The number of segments may vary from one segment to multiple segments. The profile of each segment may be linear or non-linear. Linear segments may be used in conjunction with non-linear segments. The length of each segment and/or the combined length of all segments in nanotaper 1816 may vary based on, for example, the length or width of the longitudinal surface portion 334 of optical coupler 300, the length or width of the core portion 330 of optical coupler 300, the distance D of the core portion 330 of optical coupler 300, the mode of optical signals received from or sent to optical fiber 108, the waveguide mode of the optical signals in the optical waveguide structure, and the amount of energy loss that that can be tolerated as the optical signals propagate through the nanotaper 1816. To achieve or ensure minimal energy loss, the length of the nanotaper 1816 and/or segments 1815, 1817 may be sufficient to cause or enable single modal propagation of the optical signals through the nanotaper 1816 and optical coupler 1600 with minimal or no coupling of optical energy to other optical modes or radiation modes. Nanotaper 1816 and optical coupler 1600 may form an adiabatic coupling system. The optical energy in the optical mode of uniform waveguide portion 1822 may gradually transform into the optical mode of the combined nanotaper 1816 and optical coupler 1600. As the nanotaper 1816 decreases in width, the optical energy may be more and more confined in core portion 1630 of the longitudinal surface portion 1634. The optical energy may enter the full core portion 1630 at the second end 1639 of the longitudinal surface portion 1634 and finally exit into the core portion 1624 of the optical fiber 1608. The length of the nanotaper 1816 and/or segments 1815, 1817 may be significantly greater than the wavelengths of the optical signals, and the closer in effective index the modes are, the longer the length may be. In some cases the length may be at least ten times greater than the wavelengths.

The increase in width of nanotaper 1816 in the second segment 1817 may be determined by the width of uniform waveguide portion 1822. The length L₄ of second segment 1817 may be relatively smaller than the length L₃ of first segment 1815. The length L₄ of second segment 1817 may remain relatively constant, whereas the length L₃ of first segment 1815 may be varied to achieve a desired coupling efficiency. For example, FIG. 18A shows the coupling efficiency based on various lengths L₃ of first segment 1815 ranging from 15 μm to 1000 μm. In FIG. 18A, the coupling efficiency was calculated based on a distance D of 2.15 μm, length L₄ of second segment 1817 of 5 μm, width of uniform waveguide portion 1822 of 0.45 μm, width of second segment 1817 at second end 1820 of 0.45 μm, width of second segment 1817 at its narrow end of 0.2 μm, and width of first segment 1815 at first end 1818 of 0.12 μm. As shown in FIG. 18A, the coupling efficiency generally increases as length L₃ of first segment 1815 increases.

The length of the nanotaper 1816 and/or segments 1815, 1817 and the distance D of the core portion 330 may be selected to maximize coupling efficiency between the optical IC 104 and optical fiber 108. For example, a larger distance D of core portion 330 may require a longer nanotaper 1816 in order to achieve a desired coupling efficiency. A relatively large distance D of core portion 330, such as at or near the radius of core portion 330, may require the length of nanotaper 1816 to be so large that the resultant optical coupler is impractical to use or manufacture. The distance D of core portion 330 may need to be balanced with the length of nanotaper 1816 in order to achieve a desired coupling efficiency and a practical optical coupler.

In some example configurations, when the optical coupler 1600 is positioned over the nanotaper 1816, the optical coupler 1600 and the nanotaper 1816 may form an adiabatic system or a combined adiabatic optical structure. Some or all of the dimensions and/or material properties of the optical coupler 1600 and/or the core 1710, including the nanotaper 1816, may depend on each other or chosen relative to each other. Further, the dimensions and/or properties may be determined in accordance with optical criteria. For example, the width of the nanotaper 1816 at the larger-width end 1820, the shorter-width end 1818 and the profile of the tapering between the two ends 1818, 1820 may be chosen such that an effective index of the mode at the larger-width end 1820 of the nanotaper 1816 may be greater than the index of the core portion 1630 at the first end 1631, such that the mode is predominantly confined in the nanotaper 1816 of the optical waveguide of the IC front end 1602. Additionally, the width of the nanotaper 1816 at the smaller-width end 1818 may be determined such that the effective index of an overall mode of the nanotaper 1816 and the optical coupler 1600 combined adiabatically decreases to a value that may be less than the index of the core portion 1630, but greater than the index of the cladding portion 1632. In this way, the optical mode may be predominantly confined in the core portion 1630 of the optical coupler 1600 at the shorter-width end 1818 of the nanotaper 1816.

In accordance with the above optical criteria, the relative lengths of the optical coupler 1600 and the nanotaper 1816 may be determined. In some example configurations, the lengths of the longitudinal surface portion 1634 and the nanotaper 1816 may be the same or substantially the same, as shown in FIG. 18. In alternative example configurations, the lengths may be different. In some example configurations, the maximum length of the core portion 1630 of the longitudinal surface portion 1634 may be the same, different, and/or generally determined relative to length of the nanotaper 1816, regardless of the overall length of the longitudinal surface portion 1634. This may be particularly applicable for configurations of the optical coupler 1600 where the maximum length of the core portion 1630 over the longitudinal surface portion 1634 may be different than the overall length of the longitudinal surface portion 1634.

In addition to the lengths of the optical coupler 1600 and the nanotaper 1816 being determined relative to each other, the optical coupler 1600 may be longitudinally aligned relative to the nanotaper 1816. Where the overall length of the longitudinal surface portion 1634 is the same or substantially the same as the length of the nanotaper 1816, the first end 1631 where the fourth surface portion 1640 is disposed may be aligned with the larger-width end 1820 of the nanotaper 1816, and the second end 1639 may be aligned with the smaller-width end 1818 of the nanotaper 1816. Alternatively, the longitudinal alignment between the nanotaper 1816 and the optical coupler 1600 may be relative to the length of the core portion 1630 over the longitudinal surface portion 1634.

In alternative configurations where the length of the longitudinal surface portion 1634 and/or the maximum length of the core portion 1630 is different than the length of the nanotaper 1816, longitudinal alignment may be relative to one of the ends 1818, 1820 of the nanotaper 1816, but not the other. For example, the second end 1639 of the longitudinal surface portion may be aligned with the shorter-width end 1818 of the nanotaper 1816. The first end 1631 may be disposed relative to the large-width end 1820 depending on the respective lengths of the longitudinal surface portion 1634 and the nanotaper 1816. For example, if the longitudinal surface portion 1634 is longer than the nanotaper 18416, then the first end 1631 may extend beyond the larger-width end 1820 of the nanotaper 1816 and be positioned over the uniform waveguide portion 1822. Alternatively, if the longitudinal surface portion 1634 is shorter than the nanotaper 1816, then the first end 1631 may be positioned over the nanotaper 1816 before the nanotaper 1816 is finished inversely tapering. In still other alternative configurations where the lengths are different, longitudinal alignment may be relative to the larger-width end 1820 instead of the shorter-width end 1818.

For some example manufacturing processes, the optical coupler 1600 may be axially and/or longitudinally aligned with the nanotaper 1816 passively by defining lithographically defined features on the optical IC 1604. A vision based system may be used to place the optical coupler 1600 over the IC front end 1602 aligned to the core 1710 relative to these lithographically defined features.

Referring to FIGS. 16 and 18, the optical system may also include an optical fiber support structure 1650 that is configured to receive the fiber end 1606 and uniform portion 338 of optical coupler 300 and position and support the fiber end 1606 in an optimally aligned position so that a core portion 1624 of the fiber end 1606 is in optimal axial alignment with the core portion 1630 of optical coupler 1600 at the second end 1637 to achieve optimum coupling between the optical fiber 1608 and the optical coupler 1600.

As shown in FIG. 16, the fiber end 1606 may abut or be butt coupled to the second end 1637 of the optical coupler 1600 to optically couple the fiber end 1606 with the second exposed surface portion 1637 of the optical coupler 1600. When positioned in the support structure 1650, the fiber end 1606 may be butt coupled with the second end 1637 of the optical coupler 1600 in an optimally aligned position relative to the optical coupler 1600 to achieve optimum coupling between the two optical structures.

FIG. 19 shows a cross-sectional axial view of the optical system taken along line 19-19. The support structure 1650 may include a channel 1902 formed in a body 1904 of the support structure 1650. The channel 1902 may be configured to receive, position, and support the fiber end 1606 in the optimally aligned position. In the example configuration shown in FIG. 19, the channel 1902 may be a V-groove or V-groove type channel. The V-groove 1902 may be formed using planar lithography techniques and etching, such as potassium hydroxide (KOH) etching. That is, planar lithography techniques and etching may be used to form a channel to hold the optical fiber 1608 to passively align the fiber end 1606 with the optical coupler 1600 and the optical waveguide path to achieve optimum alignment and coupling.

A size of the V-groove 1902 may be determined by an angle φ, which may depend on the material properties of the material making up the body 1904. In some example configurations, the body 1904 may be made of silicon, and the angle φ may be about 70 degrees, which may depend on the crystalline structure of the silicon. Other materials and or angles of the V-groove 1902 are possible. Also, alternative example configurations may include different types of channels other than V-grooves, such as U-shaped channels, rectangular shaped channels, or trapezoidal shaped channels. These different types of channels or shaped channels may depend on the material making up the body 1904 and/or the type of process used to make the channel 1902. Various configurations are possible.

FIG. 20 shows a cross-sectional axial view of the optical system taken along line 20-20. Channel 1902 in support structure 1650 may be configured to receive, position, and support the uniform portion 1638 of optical coupler 1600 in the optimally aligned position.

Referring back to FIG. 16, for some example configurations, the support structure 1650 may be part of or integrated with the substrate 1614 of the optical IC 1604. For example, the support structure 1650 may be part of and made of the same material as a base layer 1660 of the substrate 1614. In alternative example configurations, the support structure 1650 may be a component of the optical system that is separate from and/or external to the substrate 1614, and that may be positioned adjacent to or near the substrate 1614 in the optical system. Various configurations are possible.

In sum, when the core portion 1630 of the optical coupler 1600 is positioned and aligned with core 1710 of the nanotaper 1816, and the fiber end 1606 of the optical fiber 1608 is positioned in the channel 1902 (FIG. 19), the optical coupler 1600 may optically couple the waveguide path formed by the core 1710 with the optical fiber 1608 with optimum coupling efficiency. In this way, optical signals being communicated between the optical IC 1604 and the optical fiber 1608 may transition between the waveguide mode and optical fiber modes with minimum loss and/or maximum coupling efficiency.

The optical system shown in FIGS. 16-20 is not limited to including all of the optical coupler 1600, the optical IC 1604, and the optical fiber 1608. Some configurations of the optical system may include the optical IC 1604 and the optical coupler 1600, but may not include the optical fiber 1608. Alternatively, the optical system may include the optical coupler 1600 and the optical IC 1604 without the support structure 1650, and the support structure 1650 may be considered a component that is separate to the optical system. In still other example alternative configurations, the optical system may include the IC front end 1602 without other portions of the optical IC 1604. For example, the IC front end 1602 may be a standalone component that is considered separate from other optical IC portions. The standalone IC front end 1602 may be integrated with the optical coupler 1600, and together, the IC front end 1602 and the optical coupler 1600 may be used or implemented with one or more optical integrated circuits. Various configurations or combinations of configurations of the optical system are possible.

In addition, the optical system shown and described with reference to FIGS. 16-20 is described for optical ICs using SOI. The components and features of the optical system may be equally or similarly applicable to optical ICs that use material technologies other than SOI or that use other types of semiconductor materials, such as Germanium (Ge) or compound semiconductor materials, such as Gallium Arsenide (GaAs), Aluminium Gallium Arsenide (AlₓGaₓAs), Indium Phosphide (InP), Indium Gallium Arsenide (InₓGa₁₋ₓAs), Indium Gallium Arsenide Phosphide (InₓGa₁₋ₓAs_{y}P_{1-y}), Indium Aluminum Arsenide (InₓAl₁₋ₓAs), Indium Aluminum Gallium Arsenide (InₓAl_{y}Ga_{1-x-y}As), Gallium Nitride (GaN), Aluminum Gallium Nitride (AlₓGa₁₋ₓN), Aluminum Nitride (AlN), or Gallium Antimodide (GaSb), as examples. Alternatively, the substrate 1614 and the core 1710 may be made of one or more polymers or polymer materials. Other materials or configurations of materials are possible.

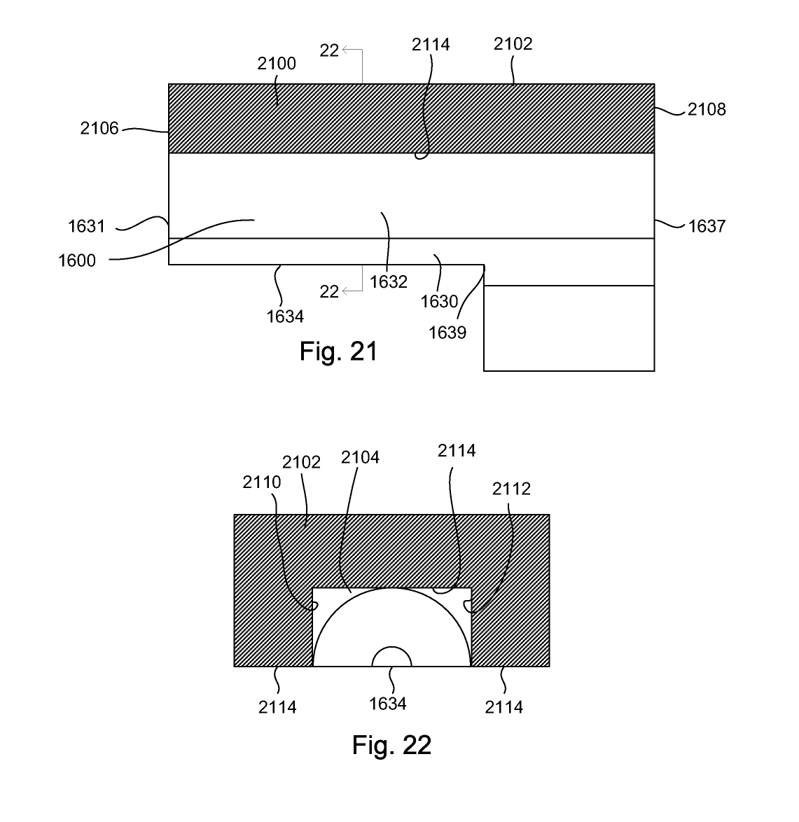

For some example configurations, the optical coupler may be disposed or positioned within a housing for manufacturability or support. FIGS. 21-22 show various views of the optical coupler 1600 positioned in an example housing 2100. In alternative embodiments, other example optical couplers, including those previously shown and described with reference to FIGS. 3-20, may be similarly positioned within the example housing 2100.

The housing 2100 may include a body 2102 and a channel 2104 extending in the body 2102 from a first end 2106 to a second, opposing end 2108. The optical coupler 1600 may be positioned in the channel 2104. The channel 2104 may have a height or depth that does not increase or decrease. Alternatively, the channel 2104 may have a height or depth that increases in accordance with the diameter of optical coupler 1600. When the optical coupler 1600 is positioned in the channel 2104 of the housing 2100, a base surface 2114 of the body 2102 may be coplanar or substantially coplanar with the longitudinal surface portion 1634 of the outer surface of the optical coupler 1600. The coplanar surfaces 1634, 2114 may be suitable for mounting and affixing the optical coupler 1600 with the housing 2100 to a top layer of an optical IC.

For the example housing 2100, the body 2102 may be made of a material that is the same or similar to the fiber optic materials used for the core portion 1630 or the cladding portion 1632 of the optical coupler 1600. An example material may be glass. When glass is the material used for the body 2102, a cutting procedure in which a cutting mechanism, such as a saw cutting into the body 2102, may be a suitable removal procedure to remove material from the body to form the channel 2104. In alternative configurations, an etching process may be used to remove the glass material from the body to form the channel 2104.

The cutting procedure, or the removal procedure generally, may determine the cross-sectional shape for the channel 2104. As shown in FIG. 22, the channel 2104 may have a generally rectangular cross-sectional shape, which may be defined or determined by inner walls 2110, 2112, and 2114. Cross-sectional shapes other than rectangular, such as U-shaped or trapezoidal shapes, may be formed, depending on the cutting mechanism and/or the material used for the body 2102. For example, in alternative example embodiments, the body 2102 may be made of a material, such as silicon, in which etching and planar lithography techniques may be used to form the channel 2104. For these alternative embodiments, the channel 2104 may be a V-groove, similar to the V-groove 1902 shown in FIG. 19.

As shown in FIG. 21, the length of the housing 2100 from the first end 2106 to the second end 2108 may be the same or substantially the same as the length of the optical coupler 1600 from the first end 1631 to the second end 1637. Alternatively, the lengths may be different and in some example configurations, the optical coupler 1600 may extend beyond the ends 2106, 2108 of the housing 2100, depending on the process used to manufacture the optical coupler 1600 and the housing 2100.

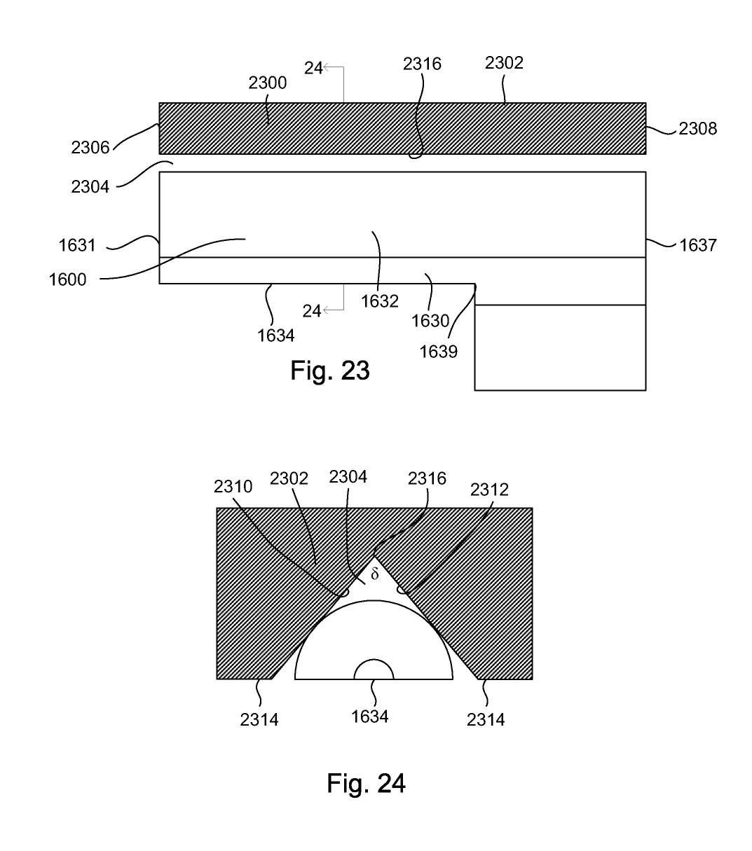

FIGS. 23-24 show various views of the optical coupler 1600 positioned in an alternative example housing 2300 that includes a body 2302 and a channel 2304 extending in the body 2302 from a first end 2306 to a second end 2308. The alternative example housing 2300 may be made of a material in which etching and planar lithography techniques may be a suitable removal process to form the channel 2304, such as silicon.

In the example configuration shown in FIGS. 23-24, the channel 2304 may be formed as a V-groove extending in the body 2302 of the housing 2300, which may be similar to the V-groove 1902 shown in FIG. 19. The V-groove 2304 may be formed using etching and planar lithography techniques. The V-groove channel 2304 may be defined or determined by inner walls 2310, 2312 of the body 2302. The V-groove 2304 may also be defined or determined by an angle δ formed by an intersection of the two inner walls 2310, 2312, such as at a point or corner 2316, although other shaped intersections are possible depending on the etching and lithography techniques used. Also, the angle δ may depend on the material properties of the material making up the body 2302. In some example configurations, the body 2302 may be made of silicon, and the angle δ may be about 70 degrees, which may depend on the crystalline structure of the silicon, as previously described.

As shown in FIGS. 23-24, when the optical coupler 1600 is positioned in the housing 2300, the base surface 2314 may be coplanar or substantially coplanar with the longitudinal surface portion 1634 of the outer surface of the optical coupler 1600. So that the longitudinal surface portion 1634 and the base surface 2314 may be flush or coplanar. The angle δ of the V-groove 2304 may remain constant over the length.

As shown by the cross-sectional views in FIG. 24, the height of the V-groove 2304 may be determined or defined as a distance extending from a point or position coplanar with the base surface 2314 to the intersection 2316 of the inner walls 2310, 2312. The height may remain constant over the length of the housing 2300 in accordance with height of the optical coupler 1600.

For some configurations, the example housing 2100 made of glass (i.e., a material that is the same or similar to the fiber optic materials used for optical coupler 1600) may be preferred over the example housing 2300 made of silicon (i.e., a material different than the fiber optic materials used for the optical coupler 1600). In particular, when the materials are the same or similar, an optical fiber may be integrated with the housing before the optical coupler is formed from the optical fiber. For example, the optical fiber may be positioned in a channel of uniform height in the glass housing. Once the optical fiber and the housing are integral components, any removal processes performed on the optical fiber to form the optical coupler may similarly and simultaneously be formed on the housing. As a result, the longitudinal surface portion of the optical coupler and the base surface of the glass housing may be more co-planar with each other. In contrast, when silicon is used, removal processes performed on an optical fiber to form the optical coupler may not be used to remove silicon. Instead, a channel, such as a V-groove, may be formed, and the optical fiber may be positioned in the V-groove. A portion of the optical fiber may protrude or extend beyond the V-groove, and this portion may be removed to form the optical coupler. The resulting co-planar longitudinal surface portion and the base surface of the silicon housing may not be as co-planar or smooth as where a glass housing is used.

FIGS. 21-24 show the optical coupler 1600 positioned in the example housings 2100, 2300 in isolation. However, the optical coupler 1600 positioned in the housing 2100 or the housing 2300 may be used or implemented together in an optical system, such as the optical system shown in FIGS. 16-20. For example, the optical coupler 1600 positioned in the housing 2100 or the housing 2300 may be positioned over and affixed to the top layer 1668, as previously described.

The above description with reference to FIGS. 3-24 describes an optical coupler that is configured to optically couple an optical fiber with a single fiber optic core with a single waveguide path of an optical IC. Alternative optical systems may include a plurality or an array of optical waveguide paths that may communicate optical signals to a plurality or an array of optical fibers.

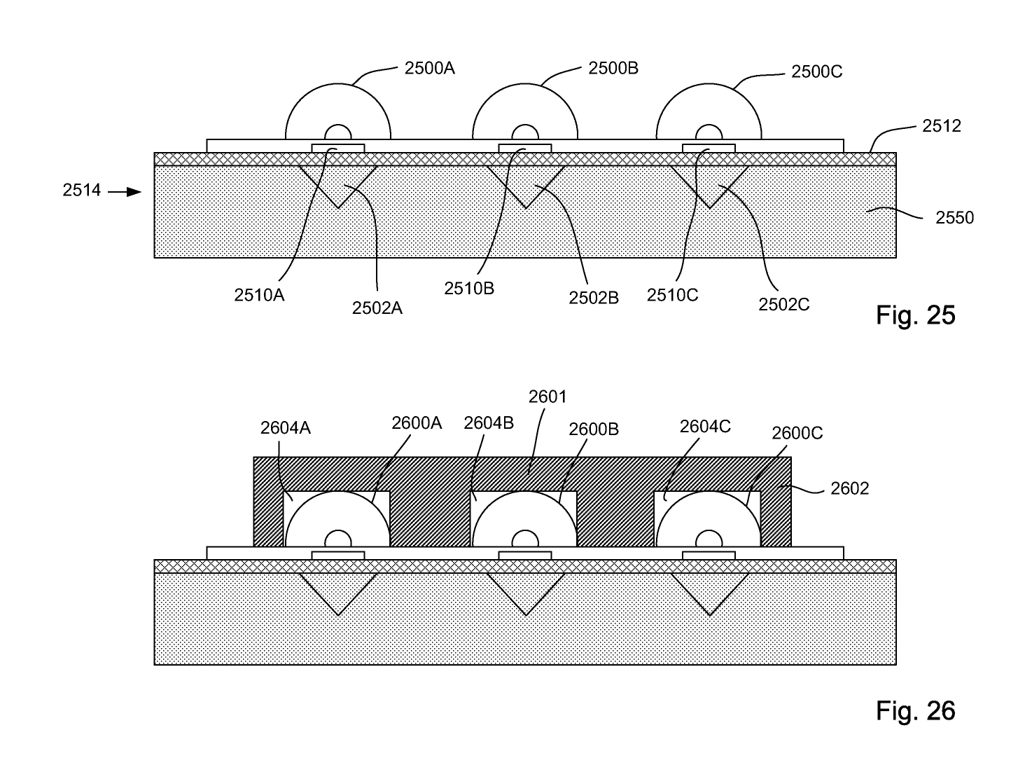

FIG. 25 shows a cross-sectional view of an example optical system that includes a plurality of waveguide paths 2510A, 2510B, 2510C disposed on a BOX layer 2512 of a substrate 2514. FIG. 25 shows three waveguide paths 2510A-C, although any number of optical waveguide paths may be included. A plurality of optical couplers 2500A-2500C, which may be configured in accordance with the example optical couplers shown in FIGS. 3-20, may be used to optically couple the plurality of waveguide paths 2510A-2510C with a plurality of optical fibers (not shown). Each of the optical couplers 2500A-2500C may be disposed over and aligned with one of the optical waveguide paths 2510A-2510C. In addition, as shown in FIG. 25, a support structure 2550 may include a plurality of channels 2502A-2502C to receive the plurality of optical fibers and passively align the plurality of optical fibers with the plurality of optical couplers 2500A-2500C. The channels 2502A-2502C, which may be V-grooves as shown in FIG. 19, may be formed using planar lithography and etching techniques, as previously described. The V-grooves 2502A-2502C may be separated by a pitch, which may be defined and/or supported by the etching and planar lithography techniques used to form the V-grooves.

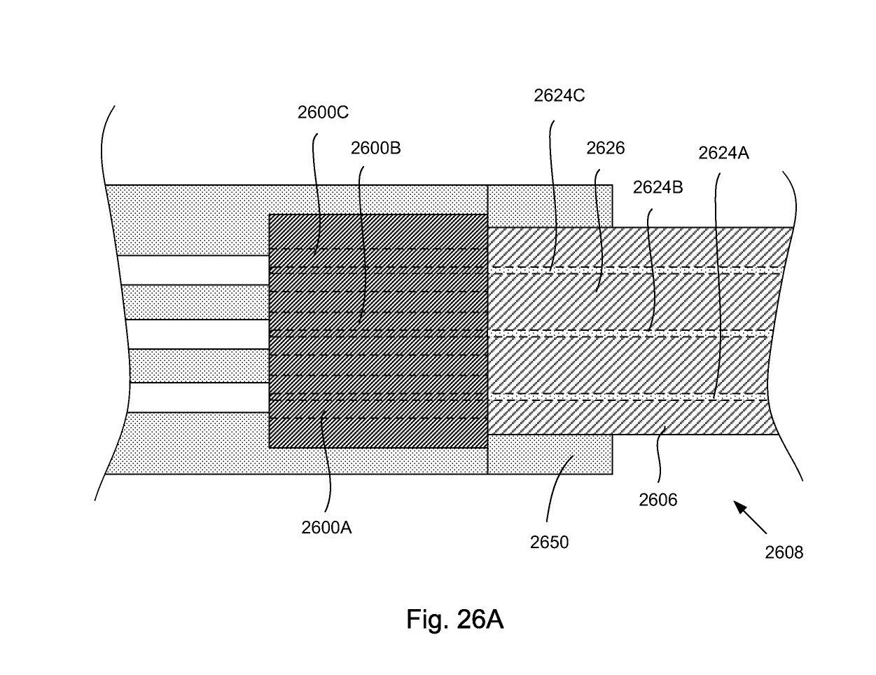

FIG. 26 shows a cross-sectional view of another example optical system that includes a plurality of optical couplers 2600A-2600C, which may be configured in accordance with the optical couplers shown in FIGS. 3-20. The optical system shown in FIG. 26 is similar to the optical system shown in FIG. 25, and further includes a housing 2601 configured to house the plurality of optical couplers 2600A-2600C. The housing 2601 may be configured and/or formed similarly to the example housing 2100 shown in FIGS. 21-22, or the example housing 2300 shown in FIGS. 23-24. The housing 2601 includes a body 2602 and a plurality of channels 2604A-2604C configured to house the plurality of optical couplers 2600A-2600C. As shown in FIG. 26, the housing 2601 may include a single integrated body 2602. In alternative example configurations, the housing 2601 may include a plurality of separate bodies, each configured with one or more channels to house one or more optical couplers. Various configurations are possible.

The optical couplers 2500A-C, 2600A-C shown in FIGS. 25-26 may be used to optically couple a plurality of optical waveguide paths of an optical IC with a plurality of single core optical fibers. In other systems, the optical couplers 2500A-C, 2600A-C may be used to optically couple a plurality of optical waveguide paths of an optical IC with a single optical fiber that includes multiple cores (i.e., a multi-core optical fiber). Each of the optical couplers 2500A-C or 2600A-C may be configured to optically couple one core of the multi-core optical fiber with one of the optical waveguide paths of the optical IC. To illustrate, FIG. 26A shows a top view of the example optical system shown in FIG. 26, and further shows a fiber end 2606 of a multi-core optical fiber 2608 positioned in a support structure 2650 and butt coupled to the optical couplers 2600A-2600C (shown as dotted lines). The multi-core optical fiber 2608 is shown as including three cores 2624A, 2624B, and 2624C encased or embedded in a single cladding 2626. Each of the cores 2624A-2624C may be optically coupled to one of the optical couplers 2600A-2600C. In particular, as shown in FIG. 26A, the first core 2624A is optically coupled to the first optical coupler 2600A, the second core 2624B is optically coupled to the second optical coupler 2600B, and the third core 2624C is optically coupled to the third optical coupler 2600C.

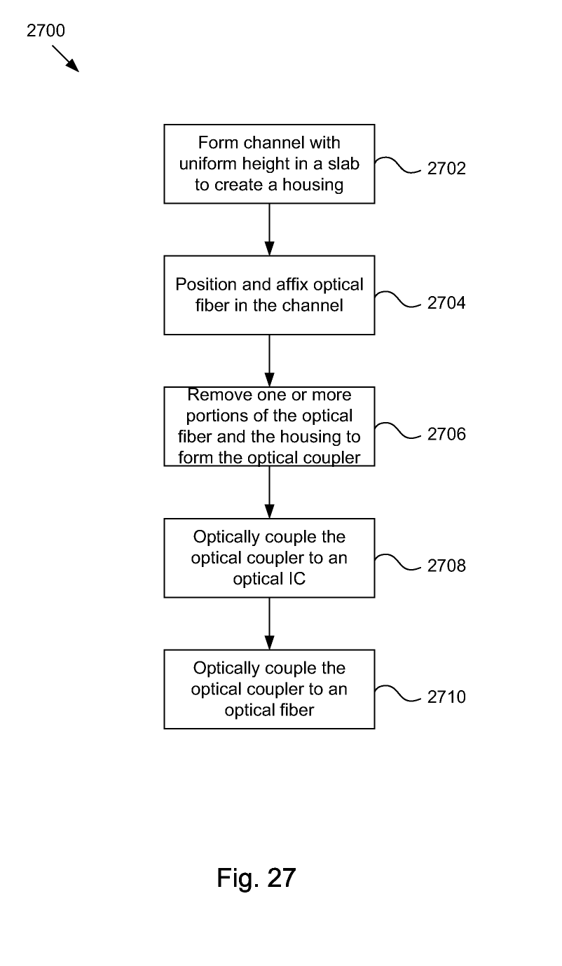

The present description also describes example methods of manufacturing an optical coupler with a housing and optically coupling the optical coupler with an optical waveguide path and an optical fiber. FIG. 27 shows a flow chart of an example method 2700 of manufacturing an optical coupler with a housing having a uniform depth channel. At block 2702, a channel with a uniform or substantially uniform depth may be formed in a slab to create the housing. The channel may be formed using various processes, depending on the material used for the housing. Example processes may include cutting or etching. For example, where glass is used, the channel may be formed using a cutting process, in which a saw or other cutting mechanism may be used to cut into the glass slab to form the channel. Alternatively, etching techniques may be used. As another example, where silicon is used as the material for the housing, the channel may be formed through planar lithography and etching techniques. The channel may be formed to have a uniform depth between opposing ends of the formed channel. In some examples, the depth of the channel may be the same or substantially the same as a size or diameter of an optical fiber used to make the optical coupler.

At block 2704, after the channel is formed in the slab, a portion, such as an end, of an optical fiber may be positioned in the channel. Also, at block 2704, the portion of the optical fiber may be secured in the channel by applying an adhesive material, such as an epoxy, which may affix the portion of the optical fiber positioned in the channel to inner walls of the slab defining the channel. When affixed to the inner walls of the slab, the slab and the optical fiber may form a combined or integrated structure.

At block 2706, one or more removal processes may be performed on the optical fiber positioned in the channel to form the optical coupler positioned in the housing. For example, a first removal process may remove a first portion of the optical fiber and the housing from a second portion of the optical fiber with a first cut that is parallel or substantially parallel to a longitudinal axis of the optical fiber and a second cut that is perpendicular or substantially perpendicular to a longitudinal axis of the optical fiber. The second portion may be used for the optical coupler. After the first removal process is performed, an outer surface that includes a longitudinal exposed surface portion and a second exposed surface portion may be formed. Both exposed portions may include core and cladding portions of the optical fiber. One or more additional removal processes may be performed to remove further additional portions from the second portion formed from the first removal process. The additional removal processes may be performed to form an overall shape or size of the optical coupler and the housing. In particular, the additional removal processes may modify or reduce a length of the longitudinal surface portion and/or modify an orientation of the third exposed surface portion relative to the longitudinal exposed surface portion.

Various techniques may be used to perform the removal processes, including polishing, cleaving (e.g., laser cleaving), slicing, grinding, or combinations thereof. For example, a relatively large amount of the slab and the optical fiber may be removed using cleaving techniques, and a remaining relatively small amount of the housing and the optical fiber (e.g., 4-5 μm) may be removed using polishing techniques. Other techniques, currently known or later developed, may be used during the removal processes. Also, where the housing is made of glass or other similar material as the materials of the optical fiber, the various techniques or processes used to remove portions of the optical fiber to form the optical coupler—such as cleaving, slicing, grinding, polishing etc.—may also be used to remove portions of the housing. In this way, any removal processes performed on the optical fiber may simultaneously be performed on the housing, which may yield a substantially uniform or smooth overall surface between the longitudinal surface portion of the optical coupler and a base surface portion of the housing.

Additional or further manufacturing processes may be performed to optically couple the optical coupler and housing with a waveguide path of an optical IC. For example, at block 2708, the optical coupler and the housing may be positioned over and/or affixed to a front end of the optical IC. In particular, the optical coupler may be positioned over and/or aligned with a nanotaper portion of an optical waveguide path at a front end of the optical waveguide path. For some examples, the optical coupler may be axially and/or longitudinally aligned with the nanotaper passively by implementing lithographically defined features on the optical IC. A vision based system may be used to place the optical coupler over the IC front end aligned to the nanotaper relative to these lithographically defined features.

Also, at block 2708 the optical coupler and housing may be affixed to the optical IC. To affix the optical coupler to the optical IC, one or more optically transparent adhesive portions may be applied to a top layer of the optical IC. In some examples, the adhesive portion may be a top sub-layer that may be added or applied over a core of the optical waveguide. In addition or alternatively, the adhesive portion may be applied by filling trenches extending longitudinally along sides of the core. The trenches may be formed using various etching techniques, such as KOH or DRIE as examples. After the trenches are formed, the trenches may be filled with the adhesive material.

Still further or additional processes may be performed to optically couple the optical coupler with a fiber end of an optical fiber. For example, at block 2710, a channel may be formed in a substrate or support structure portion of the optical IC. The channel may be formed using various techniques such as planar lithography and etching. The channel may be aligned with an optical waveguide path of the optical IC. Also, at block 2710, after the channel is formed, the fiber end of the optical fiber may be positioned in the channel. When positioned in the channel, the fiber end may be butt coupled with the third exposed surface portion of the optical coupler.

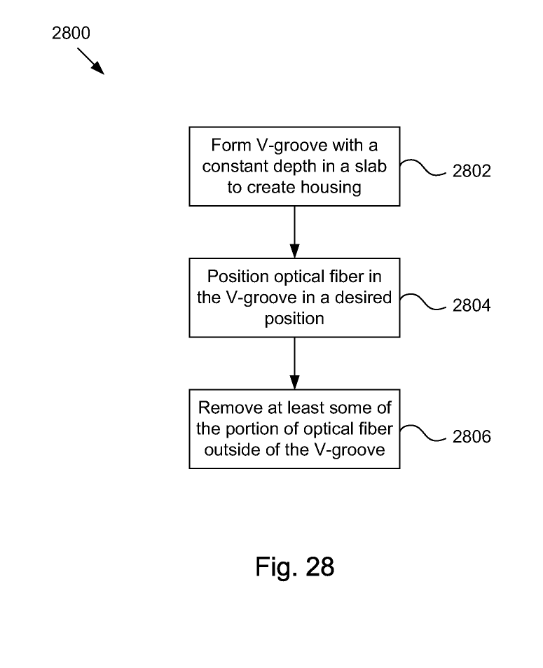

FIG. 28 shows a flow chart of another example method 2800 of manufacturing an optical coupler with a housing made of an etchable material, such as silicon. At block 2802, a channel may be formed in a slab to create the housing. The channel may be a V-groove trench that is formed using planar lithography and etching techniques. The V-groove trench may be etched to have a height or depth corresponding to a height of the optical coupler to be formed, which may depend on the distance D. The height or depth of the V-groove trench may be varied by increasing the width of a mask layer defining the V-groove trench along its length during the lithography and/or etching processes.

At block 2804, after the channel is formed in the slab and the housing is created, a portion of an optical fiber may be inserted and positioned at a desired position in the V-groove. The optical fiber may be positioned in the V-groove trench such that some core material is in the V-groove at both ends of the housing. Also, at block 2804, once the optical fiber is positioned in the desired position, an epoxy or other adhesive material may be applied within the V-groove around the optical fiber to affix the optical fiber to the housing.

When the optical fiber is in the desired position, only a portion of the optical fiber may be within or inside the V-groove, and a remaining portion may be located outside of the V-groove (and the housing generally). At block 2806, at least some of the remaining, outside portion may be removed or detached from the portion of the optical fiber in the V-groove. The outside portion may be removed such that after the outside portion is removed, the portion of optical fiber inside the V-groove trench has a flat and/or polished surface that includes both the core and cladding portions of the optical fiber. The flat and/or polished surface may be flush or substantially even with a base surface of the housing. Various techniques may be used to remove the outside portion, including polishing, cleaving (e.g., laser cleaving), slicing, grinding, or combinations thereof. For example, a relatively large amount of the outside portion may be removed using cleaving techniques, and a remaining relative small amount of the outside portion (e.g., 4-5 μm) may be removed using polishing techniques. Other techniques, currently known or later developed, may be used during the removal process. After the removal process is performed at block 2806, an optical coupler made of an optical fiber structure with a constant height and that has a flat, polished surface exposing the core of the optical fiber may be created.

After the flat surface is formed, other portions of the outside portion may still remain. For some configurations, all of the remaining portions may be removed as well using all or some of the removal techniques or processes described above. For other configurations, at least some of the remaining portions may be kept attached to the optical fiber portion in the V-groove.

After the flat surface is formed and other portions of the outside portion are optionally removed, further or additional acts may be performed to optically couple the optical coupler positioned in the housing with an optical waveguide path of an optical IC and a fiber end of an optical fiber, as described above.

The above-described methods 2700 and 2800 are described for making a single optical coupler disposed in a single channel. Similar processing techniques may be used to make a plurality of optical couplers disposed in a plurality of channels of a housing.

Various embodiments described herein can be used alone or in combination with one another. The foregoing detailed description has described only a few of the many possible implementations of the present invention. For this reason, this detailed description is intended by way of illustration, and not by way of limitation.

We claim:

1. An apparatus comprising:
an optical coupler comprising:
a fiber optic structure that comprises a core portion and a cladding portion, wherein an outer surface of the fiber optic structure comprises;
a first outer surface portion configured to optically couple the optical coupler with an optical waveguide, wherein the first outer surface portion extends in a longitudinal direction of the fiber optic structure;
a second outer surface portion adjacent to the first outer surface portion, wherein the second outer surface portion extends transverse to the longitudinal direction of the fiber optic structure; and
a third outer surface portion configured to optically couple the optical coupler with an optical fiber.

2. The apparatus of claim 1, wherein the first outer surface portion, the second outer surface portion, and third outer surface portion each include the core portion and the cladding portion.

3. The apparatus of claim 1, wherein the third outer surface portion is separated from the first outer surface portion.

4. The apparatus of claim 1, wherein the first outer surface portion is substantially parallel to a longitudinal axis of the fiber optic structure.

5. The apparatus of claim 1, wherein the second outer surface portion is substantially perpendicular to the first outer surface portion.

6. The apparatus of claim 1, wherein the first outer surface portion has a rectangular shape.

7. The apparatus of claim 1, wherein the outer surface of the fiber optic structure further comprises a fourth outer surface portion adjacent to the first outer surface portion, the fourth outer surface portion opposing the third outer surface portion.

8. The apparatus of claim 7, wherein the outer surface of the fiber optic structure further comprises a fifth outer surface portion, wherein the fifth outer surface portion is a rounded outer surface portion that comprises only the cladding portion, and wherein the fifth outer surface portion extends longitudinally from the fourth outer surface portion to the third outer surface portion.

9. The apparatus of claim 1, wherein the first outer surface portion is offset a first distance from a longitudinal axis located at the center of the core portion, wherein the first distance is in a range of about 47% to 57% of a radius of the core portion.

10. The apparatus of claim 1, further comprising a housing, the housing comprising:
a body; and
a channel extending in the body,
wherein the fiber optic structure is disposed in the channel.

11. The apparatus of claim 10, wherein the body of the housing comprises a material that is the same as a material comprising at least one of the core portion or the cladding portion.

12. The apparatus of claim 10, wherein the body of the housing comprises silicon.

13. A system comprising:
an optical waveguide structure of an optical integrated circuit, the optical waveguide structure comprising a substrate and a waveguide core forming an optical waveguide path disposed on the substrate; and
an optical coupler disposed over the waveguide core, the optical coupler comprising a fiber optic structure that comprises a core portion and a cladding portion, wherein an outer surface of the fiber optic structure comprises:
a first outer surface portion that extends in a longitudinal direction of the fiber optic structure, the first outer surface portion being a substantially flat surface comprising the core portion and the cladding portion, wherein the first outer surface portion faces the waveguide core to optically couple the optical coupler with the waveguide core;
a second outer surface portion adjacent to the first outer surface portion, wherein the second outer surface portion extends transverse to the longitudinal direction of the fiber optic structure; and
a third outer surface portion comprising the core portion and the cladding portion.

14. The system of claim 13, wherein the waveguide core comprises a nanotaper, and wherein the core portion of the first outer surface portion faces and is aligned with the nanotaper.

15. The system of claim 14, wherein the core portion extends a first length over the first surface portion, and wherein the first length is substantially equal to a second length of the nanotaper.

16. The system of claim 13, further comprising a support structure comprising a channel configured to receive and axially align a fiber end of an optical fiber with the third outer surface portion of the fiber optic structure.

17. The system of claim 16, wherein the support structure comprises silicon and is part of the substrate, and wherein the channel comprises a lithographically-formed V-groove.

18. The system of claim 13, wherein optical coupler comprises a first optical coupler and the waveguide core comprises a first waveguide core forming a first optical waveguide path,
wherein the optical waveguide structure further comprises a second waveguide core forming a second waveguide path disposed on the substrate, and
wherein the system further comprises a second optical coupler disposed over the second waveguide core, the second optical coupler comprising a core portion and a cladding portion, the second optical coupler comprising a first outer surface portion extending in a longitudinal direction of the second optical coupler, a second outer surface portion adjacent to the first outer surface portion, wherein the second outer surface portion extends transverse to the longitudinal direction of the second optical coupler, and a third outer surface portion.

19. The system of claim of claim 18, wherein the third outer surface portion of the first optical coupler and the third outer surface portion of the second optical coupler are configured to be optically coupled to first and second core portions, respectively, of a multi-core optical fiber.

20. An apparatus comprising:
an optical coupler to optically couple a waveguide core of an optical integrated circuit with an optical fiber, the optical coupler comprising a fiber optic structure that comprises a core portion and a cladding portion,
wherein the fiber optic structure comprises a flat outer surface portion that extends in a longitudinal direction of the fiber optic structure,
wherein the flat outer surface portion is offset a distance from a longitudinal axis located at the center of the core portion, and
wherein the flat outer surface portion comprises both the core portion and the cladding portion.
